(19) United States
(12) Patent Application Publication
(10) Pub. No.: US 2021/0216952 A1
(43) Pub. Date: Jul. 15, 2021

(54) System and Methods for Inventory Management

(71) Applicant: Adroit Worldwide Media, Inc., Aliso Viejo, CA (US)

(72) Inventors: Greg Schumacher, Aliso Viejo, CA (US); Kevin Howard, Aliso Viejo, CA (US); Matt Maslin, Aliso Viejo, CA (US)

(21) Appl. No.: 17/145,299

(22) Filed: Jan. 9, 2021

Related U.S. Application Data
(60) Provisional application No. 62/959,786, filed on Jan. 10, 2020.

(51) Int. Cl. G06Q 10/08; G06Q 10/06; G06F 30/13; G06K 9/78; G06T 7/70; H04N 5/247

(52) U.S. Cl. CPC G06Q 10/087; G06Q 10/0631; H04N 5/247; G06K 9/78; G06T 7/70; G06F 30/13

(57) ABSTRACT

A smart store management tool and methods are provided for enabling a user to design and stock an entire store. The smart store management tool may include a store builder that enables the user to use familiar techniques to create a layout of the entire retail store, as well as organize locations of gondolas and inventory within the store. A whole-store view comprising the smart store management tool may be configured to show locations and current stock of inventory within the store and enables the user to view the current status of inventory at specific locations within the store. An inventory analysis view comprising the smart store management tool may be configured to show the locations and current stock of inventory on a specific gondola or shelf that is selected by the user in the whole-store view.

### PRIORITY

This application claims the benefit of and priority to U.S. Provisional Application No. 62/959,786, filed Jan. 10, 2020, which is incorporated in its entirety herein.

### FIELD

Embodiments of the present disclosure generally relate to the field of merchandising systems. More specifically, embodiments of the disclosure relate to systems and methods for managing inventory in a retail environment.

### BACKGROUND

Retail environments are ever challenging. Consumers typically are confronted with pricing and information about a continuously increasing number of competitors and brands, including information about pricing, labeling, promotions, and the like. Traditionally, this information has been provided using print systems, such as slide-in paper systems, plastic label systems, and adhesive label systems. However, consumers are increasingly confounded by the sheer volume of printed information displayed in retail environments, and thus a growing number of consumers are turning to online shopping for day-to-day purchases. Furthermore, a retailer's overall performance and profits are significantly impacted by the challenge of getting the right products to the right places at the right time.

In addition, retailers are constantly concerned with the stocking of their shelves. A retailer may lose money due to a failure to restock inventory. For example, a customer may approach a shelf seeking to purchase a particular item; however, the shelf indicated as the location of the particular item may be empty. In some situations, a retailer may have that particular item stored in the back of the store but due to a lack of knowledge that the shelf was empty, the shelf was not restocked with the item causing the retailer to lose the money the customer would have spent on purchasing the particular item. Such a situation occurs at a high rate and may cost a retailer thousands or even millions of dollars in lost revenue each year.

Furthermore, customers often enter a retail location or pass by a retail exhibit (e.g., vending machine or small retail stand such as in a mall, an airport, a hospital, etc.) and fail to notice objects on some shelving units or fail to realize promotions or discounts apply to certain objects. When shopping at a retail location, customers are often distracted for a variety of reasons including looking at their mobile device, talking on their mobile device and/or watching children.

### BRIEF DESCRIPTION OF THE DRAWINGS

The above, and other, aspects, features, and advantages of several embodiments of the present disclosure will be more apparent from the following description as presented in conjunction with the following several figures of the drawings. The drawings refer to embodiments of the present disclosure in which:

FIG. 1 provides an illustration of an automated inventory intelligence system in accordance with some embodiments;

FIG. 2A provides a second illustration of a plurality of shelves with an automated inventory intelligence system in accordance with some embodiments;

FIG. 2B provides an illustration of a mount of the inventory camera of FIG. 2A in accordance with some embodiments;

FIG. 2C provides an illustration of the inventory camera positioned within the mount of the automated inventory intelligence system of FIGS. 2A-2B;

FIG. 3 provides a second illustration of a plurality of shelves with an automated inventory intelligence system in accordance with some embodiments;

FIG. 4 provides an illustration of a portion of an automated inventory intelligence system in accordance with some embodiments;

FIG. 5 provides an illustration of an image captured by a camera of an automated inventory intelligence system in accordance with some embodiments;

FIG. 6A provides a schematic illustrating a sensor coupled to a retail shelving unit in accordance with some embodiments in shown;

FIG. 6B provides a schematic illustrating a sensor such as an inventory camera coupled to an automated inventory intelligence system in accordance with some embodiments;

FIG. 6C provides a schematic illustrating a sensor such as an inventory camera coupled to the automated inventory intelligence system in accordance with some embodiments;

FIG. 7A provides an exemplary embodiment of a first logical representation of the automated inventory intelligence system of FIG. 1;

FIG. 7B provides an exemplary embodiment of a second logical representation of the automated inventory intelligence system of FIG. 1;

FIG. 8 provides a flowchart illustrating an exemplary method for analyzing, by the automated inventory intelligence system logic of FIGS. 7A-7B, an image of inventory to determine whether the inventory is to be restocked in accordance with some embodiments; and

FIG. 9 provides a flowchart illustrating an exemplary method for analyzing, by the automated inventory intelligence system logic of FIGS. 7A-7B, an image of inventory to determine whether the inventory is to be restocked based on a triggering event in accordance with some embodiments.

FIG. 10 provides an exemplary embodiment of the proximity sensor positioned on a cabinet display top of the automated inventory intelligence system of FIG. 1 in accordance with some embodiments;

FIG. 11A provides a first illustration of an image captured by the proximity sensor of the automated inventory intelligence system of FIG. 1 in accordance with some embodiments;

FIG. 11B provides a second illustration of an image captured by the proximity sensor of the automated inventory intelligence system of FIG. 1 in accordance with some embodiments;

FIG. 12A provides an exemplary illustration of a plurality of proximity regions based on one configuration of a proximity sensor of an automated inventory intelligence system in accordance with some embodiments;

FIG. 12B provides an exemplary illustration fascia of the automated inventory intelligence system of FIG. 12A displaying a first graphic while in a promotion state in accordance with some embodiments;

FIG. 12C provides an exemplary illustration fascia of the automated inventory intelligence system of FIG. 12A displaying a first graphic while in a product information state, in accordance with some embodiments;

FIG. 12D provides an exemplary illustration fascia of the automated inventory intelligence system of FIG. 12A displaying a first graphic while in an immersive state, in accordance with some embodiments;

FIG. 13 provides an exemplary flowchart illustrating operations corresponding to detecting whether an object is located within one of a plurality of proximity regions performed by an automated inventory intelligence system, in accordance with some embodiments;

FIG. 14 provides an exemplary flowchart illustrating operations corresponding to detecting one or more objects in one or more of a plurality of proximity regions and generating activity logs performed by an automated inventory intelligence system, in accordance with some embodiments;

FIG. 15A provides an exemplary embodiment of a first user interface display screen produced by an automated inventory intelligence system, where the first user interface display screen provides an interactive dashboard, in accordance with some embodiments;

FIG. 15B provides an exemplary embodiment of a second user interface display screen produced by an automated inventory intelligence system, where the second user interface display screen provides an interactive dashboard, in accordance with some embodiments;

FIG. 16 provides an exemplary embodiment illustration of a whole-store inventory view that shows the locations and current stock of inventory within a retail store, in accordance with some embodiments;

FIG. 17 provides an exemplary embodiment illustration of a product placement view of a gondola selected in the whole-store view of FIG. 16, in accordance with some embodiments;

FIG. 18 provides an exemplary embodiment of an inventory analysis view of a gondola selected in the whole-store view of FIG. 16, in accordance with some embodiments;

FIG. 19 provides an exemplary embodiment illustration of a whole-store layout view that shows the locations of gondola and inventory within a retail store, in accordance with some embodiments; and

FIG. 20 provides an exemplary embodiment illustration of a store builder view whereby locations of gondolas and inventory may be organized within a retail store, in accordance with some embodiments.

### DETAILED DESCRIPTION

In response to the problems outlined above, a continuing need exists for solutions that help retailers increase operational efficiencies, create intimate customer experiences, streamline processes, and provide real-time understanding of customer behavior in the store. Provided herein are automated inventory intelligence systems and methods that address the foregoing. Thus, it would be advantageous for retail locations and manufacturers that have inventory for sale at retail locations to be able to: (i) cause customers to notice a particular shelving unit, and (ii) provide entertaining and attractive graphics that grab customers' attention and also provide promotion as well as product information.

Before some particular embodiments are provided in greater detail, it should be understood that the particular embodiments provided herein do not limit the scope of the concepts provided herein. It should also be understood that a particular embodiment provided herein can have features that may be readily separated from the particular embodiment and optionally combined with or substituted for features of any of a number of other embodiments provided herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise. Unless defined otherwise, all technical and scientific terms used herein have the same meaning as commonly understood by those of ordinary skill in the art.

In general, the present disclosure describes an apparatus and a method for an automated inventory intelligence system that provides intelligence in tracking inventory on, for example retail shelves, as well intelligence in determining the proximity of retail customers as they approach, stall and pass a particular retail shelf or display and the demographics of the retail customers. In one embodiment, the automated inventory intelligence system is comprised of a cabinet display top, fascia, a proximity sensor, one or more inventory sensors, and one or more demographic tracking sensors. The cabinet display top can be configured to display animated and/or graphical content and is mounted on top of in-store shelves. In many embodiments, the fascia may include one or more panels of light-emitting diodes (LEDs) configured to display animated and/or graphical content and to mount to an in-store retail shelf. It would be understood by those skilled in the art that other light-emitting technologies may be utilized that can provide sufficient brightness, resolution, contrast, and/or color response. The automated inventory intelligence system can also include a data processing system comprising a media player that is configured to simultaneously execute (i.e., “play”) a multiplicity of media files that are displayed on the cabinet display top and/or the fascia. The cabinet display top and the fascia are typically configured to display content so as to entice potential customers to approach the shelves, and then the fascia may switch to displaying pricing and other information pertaining to the merchandise on the shelves once a potential customer approaches the shelves. The proximity sensor is configured to detect the presence of potential customers. Further, one or more inventory sensors may be configured to track the inventory stocked on one or more in-store retail shelves. The automated inventory intelligence system may create one or more alerts once the stocked inventory remaining on the shelves is reduced to a predetermined minimum threshold quantity.

1. System Architecture

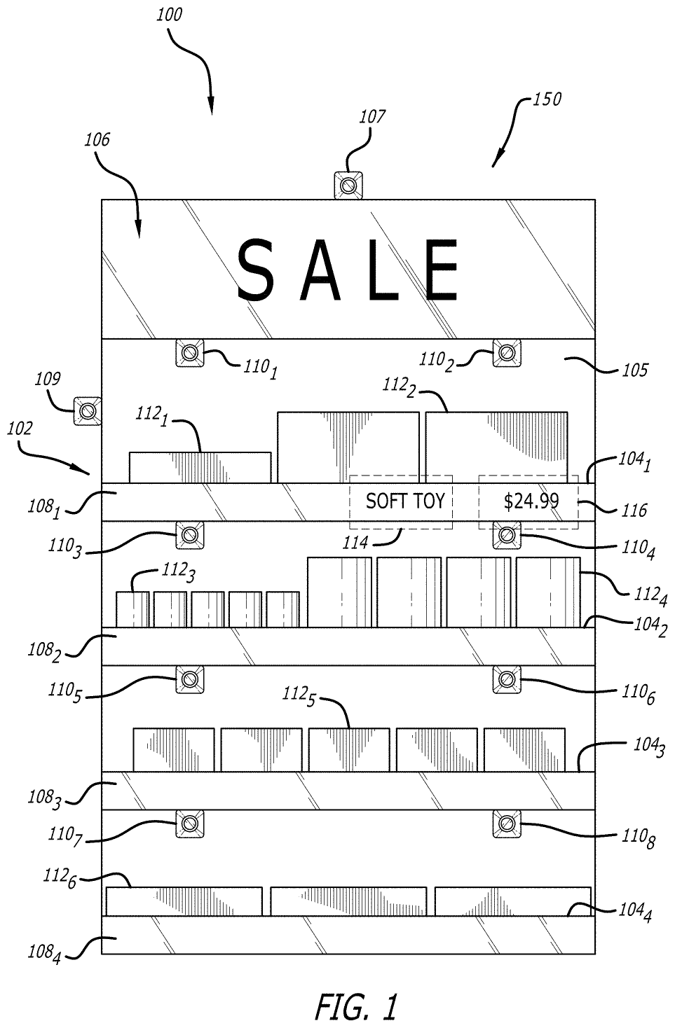

Referring now to FIG. 1, an illustration of an automated inventory intelligence system 100 in accordance with some embodiments is shown. The automated inventory intelligence system 100 comprises a proximity camera 107, fascia 108₁-108₄, a plurality of inventory cameras 110₁-110ᵢ (wherein i≥1, herein, i=8) and a facial recognition camera 109. It is noted that the disclosure is not limited to the automated inventory intelligence system 100 including a single cabinet display top 106 but may include a plurality of cabinet display tops 106. Additionally, the automated inventory intelligence system 100 is not limited to the number of fascia, shelving units, proximity cameras, facial recognition cameras and/or inventory cameras shown in FIG. 1. In typical embodiments, the automated inventory intelligence system 100 couples to a shelving unit 102, which often includes shelves 104, a back component 105 (e.g., pegboard, gridwall, slatwall, etc.) and a cabinet display top 106.

In many embodiments, the cabinet display top 106 is coupled to an upper portion of the shelving unit 102, extending vertically from the back component 105. Further, a proximity camera 107 may be positioned on top of, or otherwise affixed to, the cabinet display top 106. Although the proximity camera 107 is shown in FIG. 1 as being centrally positioned atop the cabinet display top 106, the proximity camera 107 may be positioned in different locations, such as near either end of the top of the cabinet display top 106, on a side of the cabinet display top 106 and/or at other locations coupled to the shelving unit 102 and/or the fascia 108.

The cabinet display top 106 and fascia 108 may be attached to the shelves 104 by way of any fastening means deemed suitable, wherein examples include, but are not limited or restricted to, magnets, adhesives, brackets, hardware fasteners, and the like. In a variety of embodiments, the fascia 108 and the cabinet display top 106 may each be comprised of one or more arrays of light emitting diodes (LEDs) that are configured to display visual content (e.g., still or animated content), with optional speakers, not shown, coupled thereto to provide audio content. Any of the fascia 108 and/or the cabinet display top 106 may be comprised of relatively smaller LED arrays that may be coupled together so as to tessellate the cabinet display top 106 and the fascia 108, such that the fascia and cabinet display top desirably extend along the length of the shelves 104. The smaller LED arrays may be comprised of any number of LED pixels, which may be organized into any arrangement to conveniently extend the cabinet display top 106 and the fascia 108 along the length of a plurality of shelves 104. In some embodiments, for example, a first dimension of the smaller LED arrays may be comprised of about 132 or more pixels. In some embodiments, a second dimension of the smaller LED arrays may be comprised of about 62 or more pixels.

The cabinet display top 106 and the fascia 108 may be configured to display visual content to attract the attention of potential customers. As shown in the embodiment of FIG. 1, the cabinet display top 106 may display desired visual content that extends along the length of the shelves 104. The desired content may be comprised of a single animated or graphical image that fills the entirety of the cabinet display top 106, or the desired content may be a group of smaller, multiple animated or graphical images that cover the area of the cabinet display top 106. In some embodiments, the fascia 108 may cooperate with the cabinet display top 106 to display either a single image or multiple images that appear to be spread across the height and/or length of the shelves 104.

In some embodiments, the cabinet display top 106 may display visual content selected to attract the attention of potential customers to one or more products comprising inventory 112, e.g., merchandise, located on the shelves 104. Thus, the visual content shown on the cabinet display top 106 may be specifically configured to draw the potential customers to approach the shelves 104, and is often related to the specific inventory 112 located on the corresponding shelves 104. A similar configuration with respect to visual content displayed on the fascia 108 may apply as well, as will be discussed below. The content shown on the cabinet display top 106, as well as the fascia 108, may be dynamically changed to engage and inform customers of ongoing sales, promotions, and advertising. As will be appreciated, these features offer brands and retailers a way to increase sales locally by offering customers a personalized campaign that may be easily changed quickly.

Moreover, as referenced above, portions of the fascia 108 may display visual content such as images of brand names and/or symbols representing products stocked on the shelves 104 nearest to each portion of the fascia. For example, in an embodiment, a single fascia 108 may be comprised of a first inventory portion 114 and a second inventory portion 116. The first inventory portion 114 may display an image of a brand name of inventory 112 that is stocked on the shelf above the first inventory portion 114 (e.g., in one embodiment, stocked directly above the first inventory portion 114), while the second inventory portion 116 may display pricing information for the inventory 112. Additional portions may include an image of a second brand name and/or varied pricing information when such portions correspond to inventory different than inventory 112. It is contemplated, therefore, that the fascia 108 extending along each of the shelves 104 may be sectionalized to display images corresponding to each of the products stocked on the shelves 104. It is further contemplated that the displayed images will advantageously simplify customers quickly locating desired products.

In an embodiment, the animated and/or graphical images displayed on the cabinet display top 106 and the fascia 108 are comprised of media files that are executed by way of a suitable media player. The media player is often configured to simultaneously play any desired number of media files that may be displayed on the smaller LED arrays. In some embodiments, each of the smaller LED arrays may display one media file being executed by the multiplayer, such that a group of adjacent smaller LED arrays combine to display the desired images to the customer. Still, in some embodiments, base video may be stretched to fit any of various sizes of the smaller LED arrays, and/or the cabinet display top 106 and fascia 108. It should be appreciated, therefore, that the multiplayer disclosed herein enables implementing a single media player per aisle in-store instead relying on multiple media players dedicated to each aisle.

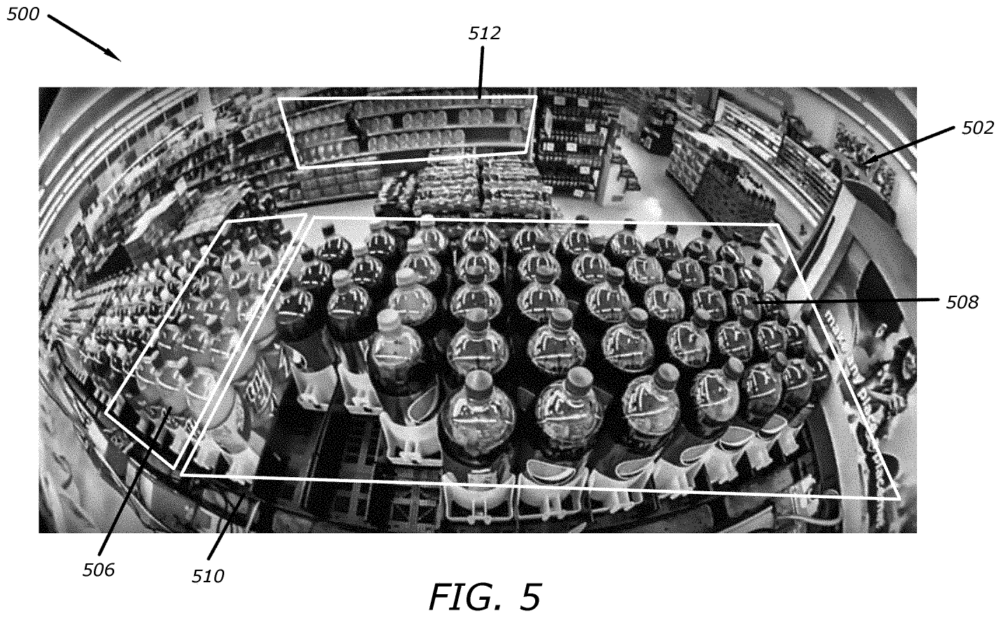

Furthermore, FIG. 1 illustrates a plurality of inventory cameras 110 (i.e., the inventory cameras 110₁-110₈). In some embodiments, the inventory cameras 110 are coupled to the shelving unit 102, e.g., via the pegboard 105, and positioned above merchandise 112, also referred to herein as “inventory.” Each of the inventory cameras 110 can be configured to monitor a portion of the inventory stocked on each shelf 104, and in some instances, may be positioned below a shelf 104, e.g., as is seen with the inventory cameras 110₃-110₈. However, in some instances, an inventory camera 110 may not be positioned below a shelf 104, e.g., as is seen with the inventory cameras 110₁-110₂. Taking the inventory camera 1104, as an example, the inventory camera 110₄ is positioned above the second inventory portion 116 and therefore capable of (and configured to), monitor the second inventory portion 116. Although, it should be noted that the inventory camera 1104 may have a viewing angle of 180° (degrees) and is capable of monitoring a larger portion of the inventory 112 on the shelf 104₂ than merely the second inventory portion 116. For example, FIG. 5 illustrates one exemplary image captured by an inventory camera having a viewing of 180°.

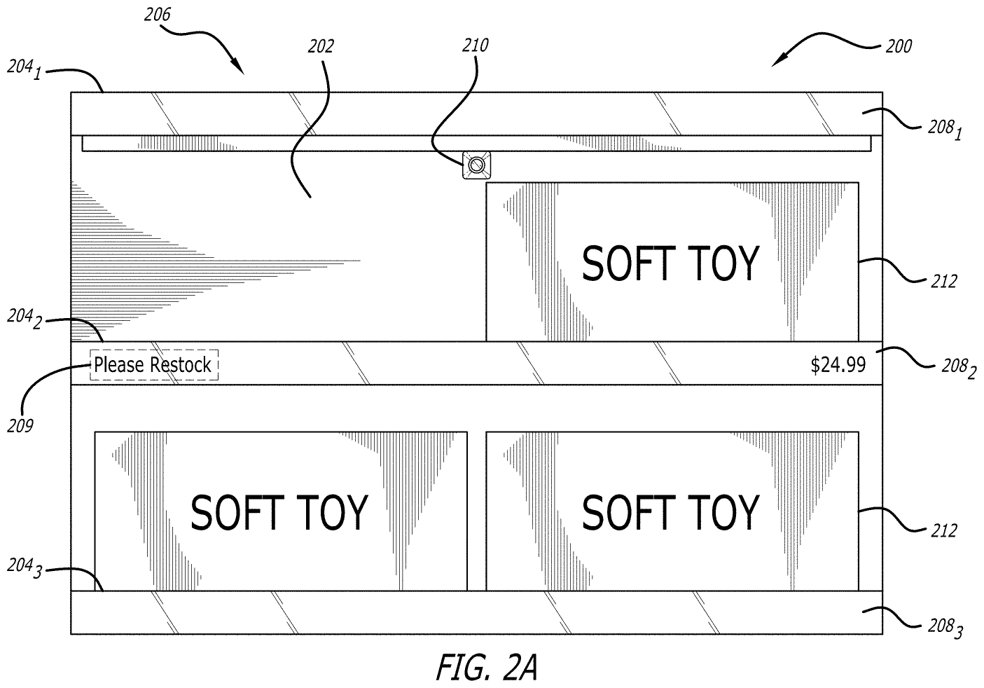

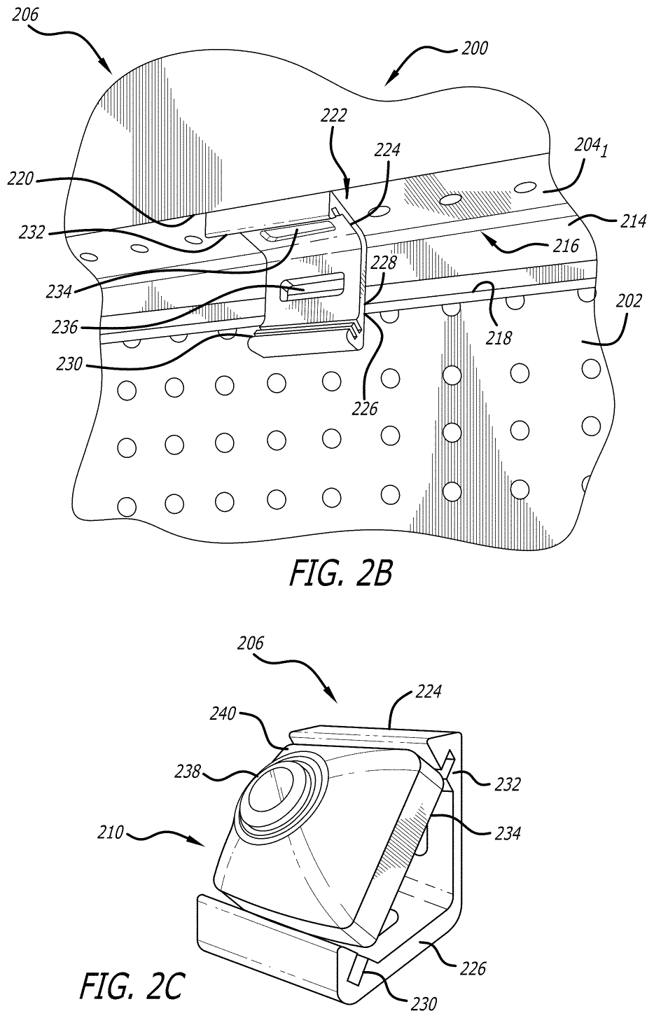

As is illustrated in FIGS. 2A-4 and 6A-6C and discussed with respect thereto, the positioning of the inventory cameras 110 may differ from the illustration of FIG. 1. In addition to being positioned differently with respect to spacing above inventory 112 on a particular shelf 104, the inventory cameras 110 degree may be affixed to the shelving unit 102 in a variety of manners, including attachment to various types of shelves 104 and monitoring of any available inventory 112 stored thereon.

In addition to the proximity camera 107 and the inventory cameras 110₁-110₈, various embodiments of the automated inventory intelligence system 100 can also include a facial recognition camera 109. In one embodiment, the facial recognition camera 109 may be coupled to the exterior of the shelving unit 102. In some embodiments, the facial recognition camera 109 may be positioned between five to six feet from the ground in order to obtain a clear image of the faces of a majority of customers. The facial recognition camera 109 may be positioned at heights other than five to six feet from the ground. The facial recognition camera 109 need not be coupled to the exterior of the shelving unit 102 as illustrated in FIG. 1; instead, the illustration of FIG. 1 is merely one embodiment. The facial recognition camera 109 may be coupled to in the interior of a side of the shelving unit 102 as well as to any portion of any of the shelves 104₁-104₄, the cabinet display top 106, the fascia 108 and/or the back component 105 of the shelving unit 102. Further, a plurality of facial recognition cameras 109 may be coupled to the shelving unit 102. In certain embodiments, the facial recognition camera 109 may be eliminated and its associated functions accomplished by any available proximity cameras 107. In these embodiments, software can be utilized to account for any discrepancy between the image and angles captured between the proximity cameras 107 as compared to the facial recognition cameras 109. In further embodiments, especially where privacy concerns are heightened, facial recognition cameras may be eliminated leaving the automated inventory intelligent system 100 to gather customer data by other means including, but not limited to, mobile phone signals/application data and/or radio-frequency identification (RFID) signals.

In some embodiments, the automated inventory intelligence system 100 may include one or more processors, a non-transitory computer-readable memory, one or more communication interfaces, and logic stored on the non-transitory computer-readable memory. The images or other data captured by the proximity camera 107, the facial recognition camera 109 and/or the inventory cameras 110₁-110₈ may be analyzed by the logic of the automated inventory intelligence system 100. The non-transitory computer-readable medium may be local storage, e.g., located at the store in which the proximity camera 107, the facial recognition camera 109 and/or the inventory cameras 110₁-110₈ reside, or may be cloud-computing storage. Similarly, the one or more processors may be local to the proximity camera 107, the facial recognition camera 109 and/or the inventory cameras 110₁-110₈ or may be provided by cloud computing services.

Examples of the environment in which the automated inventory intelligence system 100 may be located include, but are not limited or restricted to, a retailer, a warehouse, an airport, a high school, college or university, any cafeteria, a hospital lobby, a hotel lobby, a train station, or any other area in which a shelving unit for storing inventory may be located.

2. Inventory Sensors

Referring to FIG. 2A, a second illustration of a plurality of shelves with an automated inventory intelligence system in accordance with some embodiments is shown. Specifically, FIG. 2A illustrates the automated inventory intelligence system 206 coupled to a shelving unit 200. More particularly, the shelving unit 200 includes a back component 202 (e.g., pegboard) and shelves 204 (wherein shelves 204₁-204₃ are illustrated; however, the shelving unit 200 may include additional shelves). In the illustrated embodiment, the automated inventory intelligence system 206 includes fascia 208 and the inventory sensor 210 (herein the inventory sensor 210 is depicted as inventory camera). Although only a single inventory camera 210 is shown in FIG. 2A, the automated inventory intelligence system 206 may include additional inventory cameras not shown. FIG. 2A provides a clear perspective as to the positioning of the inventory camera 210 may be in one embodiment. Specifically, the inventory camera 210 is shown to be coupled to a corner formed by an underside of the shelf 204₁ and the back component 202. The positioning of the inventory camera 210 can enable the inventory camera 210 to monitor the inventory 212. Additional detail of the coupling of the inventory camera 210 to the shelving unit 200 is seen in FIG. 2B. In addition, the fascia, e.g., fascia 2082 may display pricing information (as also shown in FIG. 1) as well as display an alert, e.g., a visual indicator via LEDs of a portion of the fascia, indicating that inventory stocked on the corresponding shelf, e.g., the shelf 204₂, is to be restocked.

Referring now to FIG. 2B, an illustration of a mount of the inventory camera 210 of FIG. 2A is shown in accordance with some embodiments. The mount 222, which may be “L-shaped” in nature (i.e., two sides extending at a 90° (degree) angle from each other, is shown without the inventory camera 210 placed therein. In some embodiments, the inventory camera 210 may snap into the mount 222, which may enable inventory cameras to be easily replaced, moved, removed for charging or repair, etc. The mount 222 is shown as being coupled to a corner formed by an underside of the shelf 2041 and the back component 202. In particular, the shelving unit 200 depicted in FIG. 2B comprises a first metal runner 214 is attached to the back component 202 and a second metal runner 220 is shown as being attached to the underside of the shelf 2041. The first metal runner 214 includes a first groove 216 and a second groove 218 to which flanges of the mount 222, such as the flange 228, may slide or otherwise couple. Although not shown, a groove is also formed by the second metal runner 220, which may also assist in the coupling of the mount 222.

In the embodiment illustrated, the mount 222 includes a top component 224, a side component 226, an optional flange 228, bottom grips 230, top grips 232, a top cavity 234 and side cavity 236. In addition, although not shown, a flange extending from the top component 224 to couple with the second metal runner 220 may be included. The inventory camera 210 may couple to the mount 222 and be securely held in place by the bottom grips 230 and the top grips 232. Further, the body of the inventory camera 210 may include projections that couple, e.g., mate, with the top cavity 234 and/or the side cavity 236 to prevent shifting of the inventory camera 210 upon coupling with the mount 222.

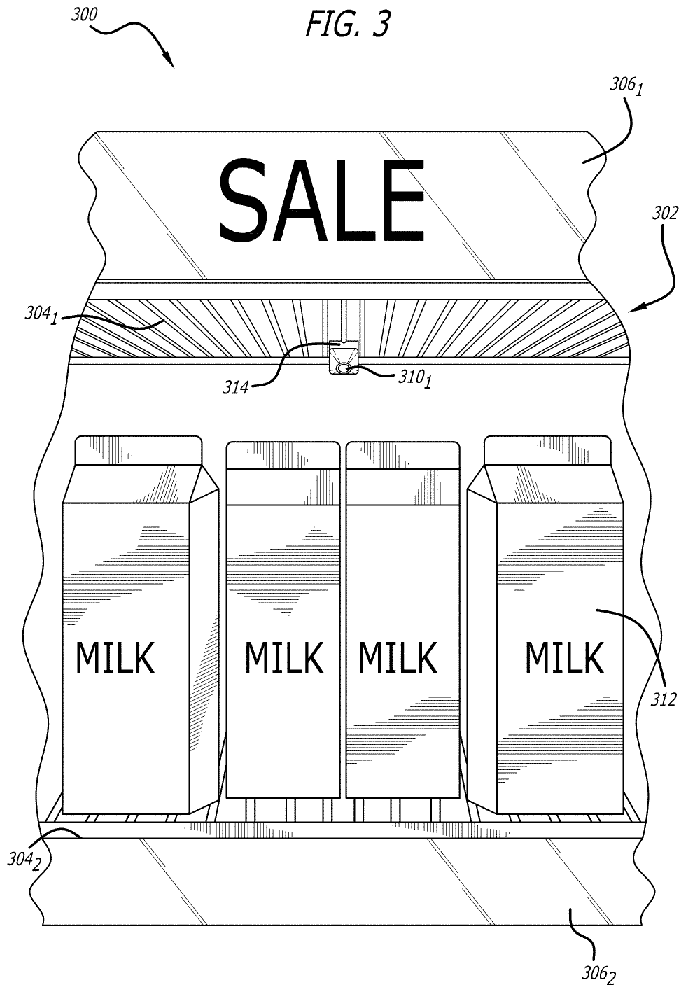

Referring to FIG. 2C, an illustration of the inventory camera 210 positioned within the mount 222 of the automated inventory intelligence system 206 of FIGS. 2A-B is shown. The inventory camera 210 is positioned within the mount 222 and includes a lens 238 and a housing 240. The inventory camera 210 is shown as having four straight sides but may take alternative forms as still be within the scope of the invention. For example, in other embodiments, the inventory camera 210 may only have two straight sides and may include two curved sides. Additionally, the inventory camera 210 may take a circular shape or include one or more circular arcs. Further, the inventory camera 210 may take the form of any polygon or other known geometric shape. In addition, the housing 240 may have an angled face such that the face of the housing 240 slopes away from the lens 238, which may be advantageous in capturing an image having a viewing angle of 180°. The inventory camera 210 may snap into the mount 222 and held in place by friction of the bottom grips 230 and top grips 232, and the force applied by the top component 224 and the side component 226. It would be understood to those skilled in the art that the mount 222 can comprise a variety of shapes depending on the camera and shelving unit 200 being utilized, as can be shown in the camera mount depicted in FIG. 3 below.

Referring now to FIG. 3, a second illustration of a plurality of shelves with an automated inventory intelligence system is shown in accordance with some embodiments. In particular, FIG. 3 illustrates an inventory camera 310₁ of the automated inventory intelligence system 300 coupled to the underside of a shelf 304₁, which is part of the shelving unit 302. In the embodiment depicted in FIG. 3, the automated inventory intelligence system 300 includes the fascia 306₁-306₂, the inventory camera 310₁ and a mount 314. In one embodiment, the mount 314 is coupled to underside of shelf 304₁, which is possible due to the configuration of the shelf 304₁, particularly, the shelf 304₁ is comprised of a series of grates. Due to the grated nature of the shelf 304₁, the mount 314 may be configured to clip directly to one or more of the grates.

It should also be noted that the shelving unit 302 is refrigerated, e.g., configured for housing milk, and includes a door, not shown. As a result of being refrigerated, the shelving unit 302 experiences temperature swings as the door is opened and closed, which often results in the temporary accumulation of condensation on the lens of the inventory camera 310₁. Thus, the logic of the automated inventory intelligence system may perform various forms of processing for handling the temporary accumulation of condensation on the lens of the inventory camera 310₁, which may include, for example, (i) sensing when the door of the shelving unit 302 is opened, e.g., via sensing activation of a light, and waiting a predetermined amount of time before taking an image capture with the inventory camera 310₁ (e.g., to wait until the condensation has dissipated), and/or (ii) capturing an image with the inventory camera 310₁, performing image processing such as object recognition techniques, and discarding the image when the object recognition techniques do not provide a confidence level of the recognized objects above a predetermined threshold (e.g., condensation blurred or otherwise obscured the image, indicating the presence of condensation).

Although not shown, in one embodiment, the inventory camera 310₁ may be coupled to the front of the shelf 304₁ and face the inventory 312. Such an embodiment may be advantageous with refrigerated shelving units such as the shelving unit 302 when a light source, not shown, is housed within the shelving unit and turns on when a door of the shelving unit is opened. More specifically, when the light source is positioned at the rear of the shelving unit, the image captured by the inventory camera 310₁ may appear clearer and less blurred in such an embodiment.

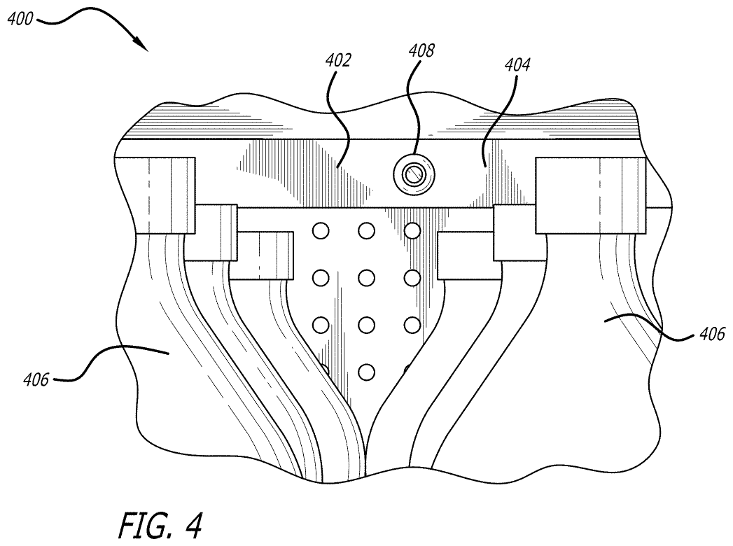

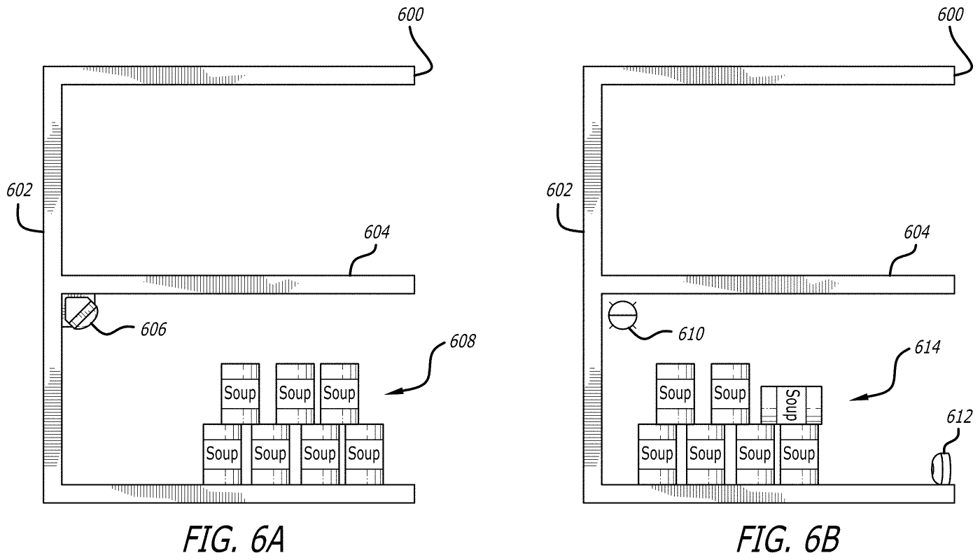

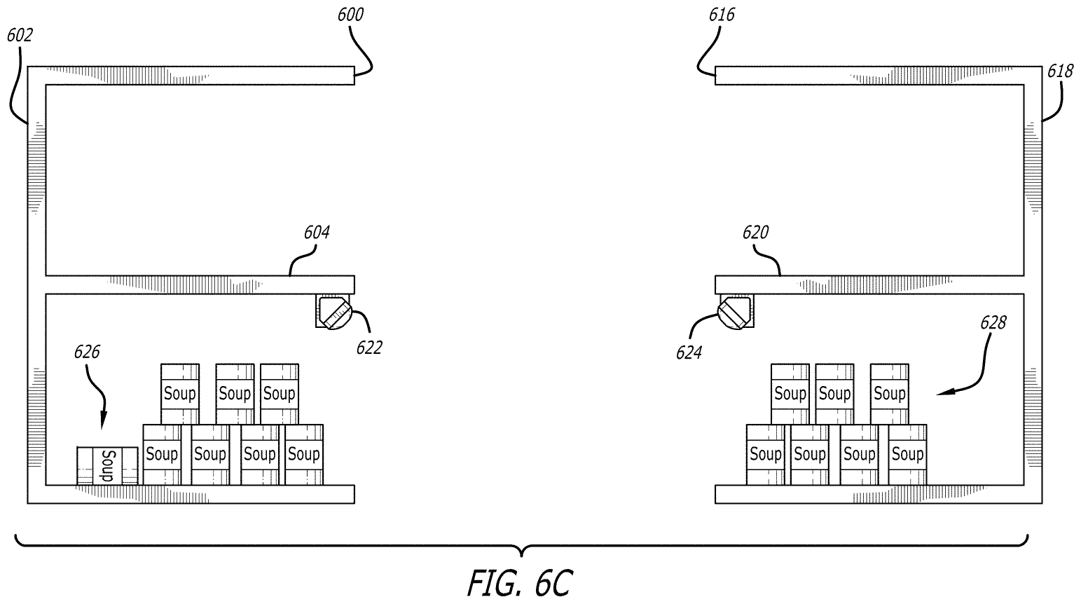

Referring to FIG. 4, an illustration of a portion of an automated inventory intelligence system is shown in accordance with some embodiments. In particular, a sensor 408 is shown positioned near merchandise 406 stocked on a shelving unit 402 of an automated inventory intelligence system 400. The sensor 408 is shown integrated in a housing 404, wherein the housing 404 may, in one embodiment, take the form of a rod that extends along at least a portion of the back component of the shelving unit and may be configured to couple to the shelving unit. As in other embodiments disclosed herein, the sensor 408 may include a digital camera; however, in other embodiments, the sensor 408 may be any sensing device whereby merchandise stocked on a shelving unit may be monitored. In the embodiment shown, the sensor 408 is configured to be coupled directly to the shelving unit 402 by way of any fastening means deemed suitable, such as, by way of non-limiting example, magnets, adhesives, brackets, hardware fasteners, and the like. In other embodiments, such as those illustrated in FIGS. 5-6 below, the sensor 408 may be coupled to the shelving unit 402 through a mounting bracket 506. Further, the location of a sensor such as the sensor 408 is not to be limited to the location shown in FIG. 4. It should be understood that the sensor 408 may be disposed in any location with respect to a retail display or warehouse storage unit whereby the stocked merchandise may be monitored. Embodiments of some alternative positioning of sensors are illustrated in FIGS. 6A-6C. Furthermore, preferred locations suited to receive the sensor 408 will generally depend upon one or more factors, such as, for example, the type of merchandise, an ability to capture a desired quantity of merchandise within the field of view of the sensor 408, as well as the methods whereby customers typically remove merchandise from the retail display units.

Any of the retail displays or warehouse storage units outfitted with the automated inventory intelligence system 400 can monitor the quantity of stocked merchandise by way of one or more sensors such as the sensor 408 and then create a notification or an alert once the remaining merchandise is reduced to a predetermined minimum threshold quantity. For example, low-inventory alerts may be created when the remaining merchandise is reduced to 50% and 20% thresholds; however, the disclosure is not intended to be so limited and thresholds may be predetermined and/or dynamically configurable (e.g., in response to weather conditions, and/or past sales history data). The low-inventory alerts may be sent to in-store staff to signal that a retail display needs to be restocked with merchandise. In some embodiments, the low-inventory alerts can include real-time images and/or stock levels of the retail displays so that staff can see the quantity of merchandise remaining on the retail displays by way of a computer or a mobile device. In some embodiments, the low-inventory alerts may be sent in the form of text messages in real time to mobile devices carried by in-store staff. As will be appreciated, the low-inventory alerts can signal in-store staff to restock the retail displays with additional merchandise to maintain a frictionless shopping experience for consumers. In addition, with the automated inventory intelligence system 400 can facilitate deeper analyses of sales performance by coupling actual sales with display shelf activity.

3. Inventory Monitoring

Referring to FIG. 5, an illustration of an image captured by a camera of an automated inventory intelligence system is shown in accordance with some embodiments. The image 500 shown in FIG. 5 illustrates the ability of an inventory camera configured for use with the automated inventory intelligence system 206 of FIGS. 2A-2C to capture the image 500 having an approximately 180° viewing angle. In certain embodiments, an inventory camera, such as the inventory camera 310₁ of FIG. 3, may be positioned within a shelving unit, such as the shelving unit 302 of FIG. 3, such that the inventory camera is located at the inner rear of the shelving unit and above a portion of inventory. In such an embodiment, the inventory camera 310₁ may capture an image such as the image 500, which includes a capture of a first inventory portion 508 and a second inventory portion 510 stocked on shelf 506. In addition, the image 500 may include a capture of a portion of the store environment 502 and alternative (or additional) inventory portion 512.

Specifically, the positioning of the inventory camera as shown in FIG. 5 enables the inventory camera to capture images such as the image 500, which may be analyzed by logic of the automated inventory intelligence system 206 to automatically and intelligently determine the amount of inventory stocked on the shelf. For example, as seen in the image 500, the first inventory portion 508 and the second inventory portion 510 may be identified by the automated inventory intelligence system 206 using object recognition techniques. For example, upon recognition of the first inventory portion 508 (e.g., recognition of Pepsi bottles), logic of the automated inventory intelligence system 206 may analyze the quantity remaining on the shelf 506. In additional embodiments, the automated inventory intelligence system 206 may determine whether a threshold number of bottles have been removed from the shelf 506. Upon determining at least the threshold number of bottles have been removed, the automated inventory intelligence system 206 may generate a report and/or an alert notifying employees and/or manufacturer that the first inventory portion 508 requires restocking. In additional embodiments, the automated inventory intelligence system 206 may determine that less than a threshold number of bottles remain on the shelf 506 and therefore the first inventory portion 508 requires restocking. Utilization of other methodologies of determining whether at least a predetermined number of items remain on a shelf for a given inventory set are within the scope of the invention. Herein, the term “inventory set” generally refers to a grouping of a particular item, e.g., a grouping of a particular type of merchandise, which may include brand, product size (12 oz. bottle v. 2 L bottle), etc.

In some embodiments, the image 500 may also be analyzed to determine the remaining items of other inventory portions such as the second inventory portion 510 and/or the alternative inventory portion 512. As seen in FIGS. 6A-6C, the inventory camera may be placed at various varying positions within, or coupled to, a shelving unit. The utilization of such alternative configurations may be dependent upon the type of shelving unit, the type of inventory being captured in images taken by the inventory camera and/or the positioning of inventory within the store environment (e.g., across an aisle).

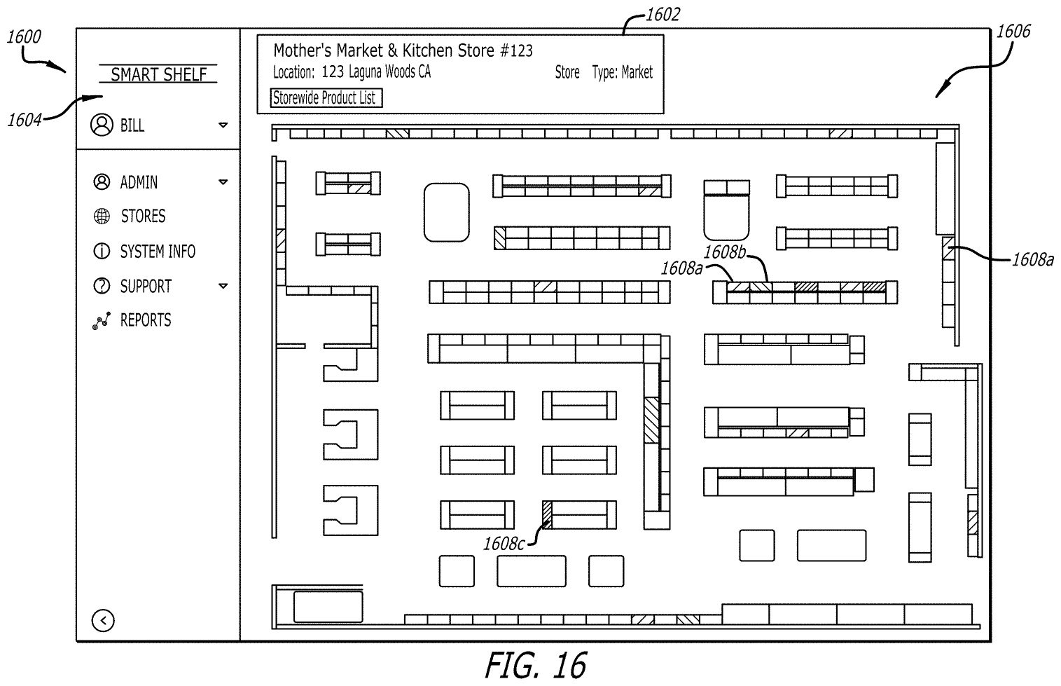

In some embodiments, one or more inventory cameras may be configured to capture images that may be used to construct a dynamic planogram, or a “dynamogram” as shown in FIG. 16, which may be used to track the positions of inventory on the shelf 506. As will be appreciated, a planogram comprises a model that may be used to indicate the placement of retail products on a shelf, such as the shelf 506. However, customers may pick up inventory items and then position the items is various other locations on the shelf 506. The continual movement of various retail products causes the existing positions of the retail products on the shelf 506 to deviate from the planogram. The dynamogram of FIG. 16 generally tracks the positions of the retail products as they are moved around on the shelf 506. As such, the dynamogram reflects the existing state of the inventory on the shelf 506, thereby enabling the automated inventory intelligence system 206 to automatically and intelligently determine the amount of inventory stocked on the shelf as well as tracking correct pricing information for misplaced inventory items. As will be appreciated, therefore, the dynamogram is configured to enable the automated inventory intelligence system 206 to provide a frictionless shopping environment when products are moved elsewhere by customers.

FIGS. 6A-6C provide schematics illustrating sensors coupled to retail displays in accordance with some embodiments. The one or more sensors are configured to be disposed in a retail environment such as by coupling the sensors to retail displays or warehouse storage units. Such retail displays include, but are not limited to, shelves, panels (e.g., pegboard, gridwall, slatwall, etc.), tables, cabinets, cases, bins, boxes, stands, and racks, and such warehouse storage includes, but is not limited to, shelves, cabinets, bins, boxes, and racks. The sensors may be coupled to the retail displays or the warehouse storage units such that one sensor is provided for every set of inventory items (e.g., one-to-one relationship), one sensor for a number of sets of inventory items (e.g., one-to-many relationship), or a combination thereof. The sensors may also be coupled to the retail displays or the warehouse storage units with more than one sensor for every set of inventory items (e.g., many-to-one relationship), more than one sensor for a number of sets of inventory items (e.g., many-to-many relationship), or a combination thereof. In an example of a many-to-one relationship, at least two sensors monitor the same set of inventory items thereby providing contemporaneous sensor data for the set of inventory items. Providing two (or more) sensors for a single set of inventory is useful for sensor data redundancy or simply having a backup. Each of FIGS. 6A-6C shows a one-to-one relationship of a sensor to a set of inventory items, but each sensor can alternatively be in one of the foregoing alternative relationships with one or more sets of inventory items.

The sensors include, but are not limited to, light- or sound-based sensors such as digital cameras and microphones, respectively. In some embodiments, the sensors are digital cameras, also referred to as “inventory cameras,” with a wide viewing angle up to a 180° viewing angle.

Referring now to FIG. 6A, a schematic illustrating a sensor such as a sensor 606 coupled to a retail shelving unit 604 is shown in accordance with some embodiments. As shown, the sensor 606, e.g., an inventory camera, may be coupled to or mounted on the retail shelving unit 604 under an upper shelf of the retail shelving unit 604, wherein the retail shelving unit 604 is a component of the housing 602 of the automated inventory intelligence system 600. In the illustrated embodiment, the inventory camera 606 is configured in an orientation to view a set of inventory items 608 on an inventory item-containing shelf beneath the upper shelf. While the inventory camera 606 is shown mounted inside the retail shelving unit 604 such as on a back (e.g., pegboard) of the housing 602 and looking out from the automated inventory intelligence system 600, the inventory camera 606 may alternatively be coupled to the upper shelf and looking in to the automated inventory intelligence system 600. Due to a wide viewing angle of up to 180°, whether looking out from or into the automated inventory intelligence system 600, the inventory camera 606 may collect visual information on sets of inventory items adjacent to the set of inventory items 608.

Referring to FIG. 6B, a schematic illustrating a sensor such as an inventory camera 612 coupled to an automated inventory intelligence system 600 is shown in accordance with some embodiments. As shown, the inventory camera 612 may be coupled to or mounted on the automated inventory intelligence system 600 on an inventory-item containing shelf of the automated inventory intelligence system 600 in an orientation to view a set of inventory items 614 on the inventory item-containing shelf. While the inventory camera 612 is shown mounted inside the automated inventory intelligence system 600 on the inventory item-containing shelf and looking in to the automated inventory intelligence system 600, which may be advantageous when a light 610 is present in a back of automated inventory intelligence system 600, the inventory camera 612 may alternatively be coupled to the inventory item-containing shelf and looking out from the automated inventory intelligence system 600. Due to a wide viewing angle of up to 180°, whether looking in to or out from the automated inventory intelligence system 600, the inventory camera 612 may collect visual information on sets of inventory items adjacent to the set of inventory items 614.

Referring to FIG. 6C, a schematic illustrating a sensor such as an inventory camera 622 coupled to the automated inventory intelligence system 600 is shown in accordance with some embodiments. In addition, FIG. 6C further provides a second housing 618 with a second sensor such as an inventory camera 624 coupled to a second upper shelf 620 and in communication with a second automated inventory intelligence system 616 in accordance with some embodiments. In certain embodiments the automated inventory intelligence system 600 and the second automated inventory intelligence system 616 may be separate and independent systems or may be communicatively coupled and/or processing data cooperatively.

As shown, the inventory camera 622 may be physically coupled to or mounted on the automated inventory intelligence system 600 in an orientation to view a set of inventory items 628 on an inventory-item containing shelf of an opposing shelving unit across an aisle such as the second automated inventory intelligence system 616. Likewise, the inventory camera 624 may be coupled to or mounted on the second automated inventory intelligence system 616 in an orientation to view a set of inventory items 626 on an inventory-item containing shelf of an opposing shelving unit across an aisle such as the automated inventory intelligence system 600. Due to wide viewing angles of up to 180°, the inventory camera 622 can collect visual information on sets of inventory items on the second automated inventory intelligence system 616 adjacent to the set of inventory items 628 (not shown), and the inventory camera 622 can collect visual information on sets of inventory items on the automated inventory intelligence system 616 adjacent to the set of inventory items 626 (not shown).

In some embodiments, inventory cameras such as inventory cameras 606, 612, 622, and 624 are coupled to or mounted on endcaps or other vantage points of the automated inventory intelligence systems to collect visual information while looking into the retail shelving units.

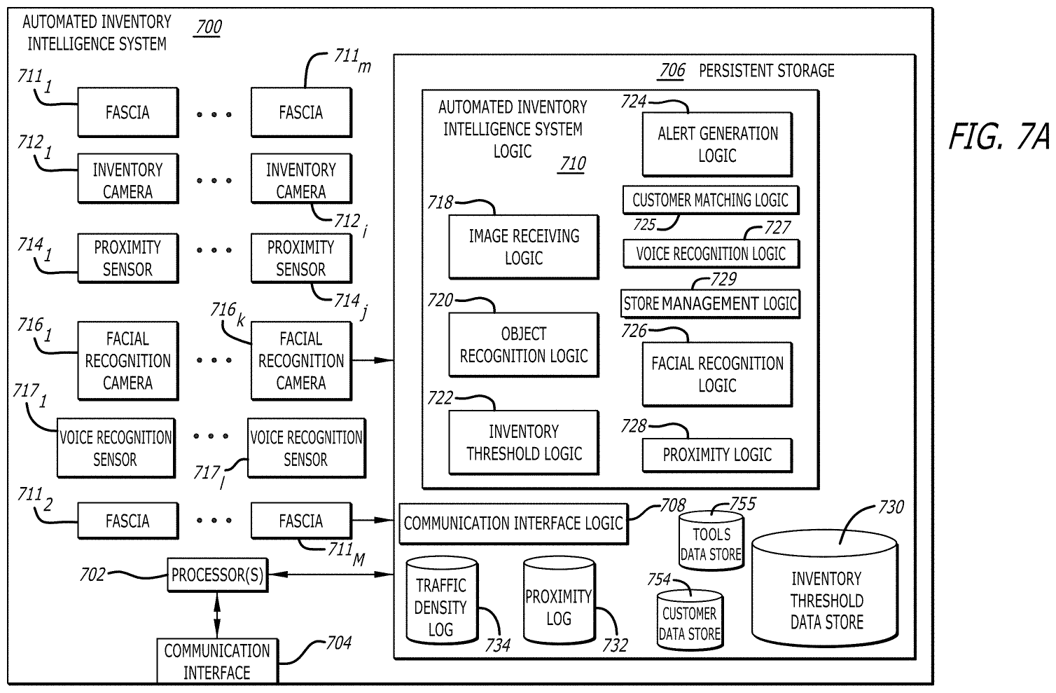

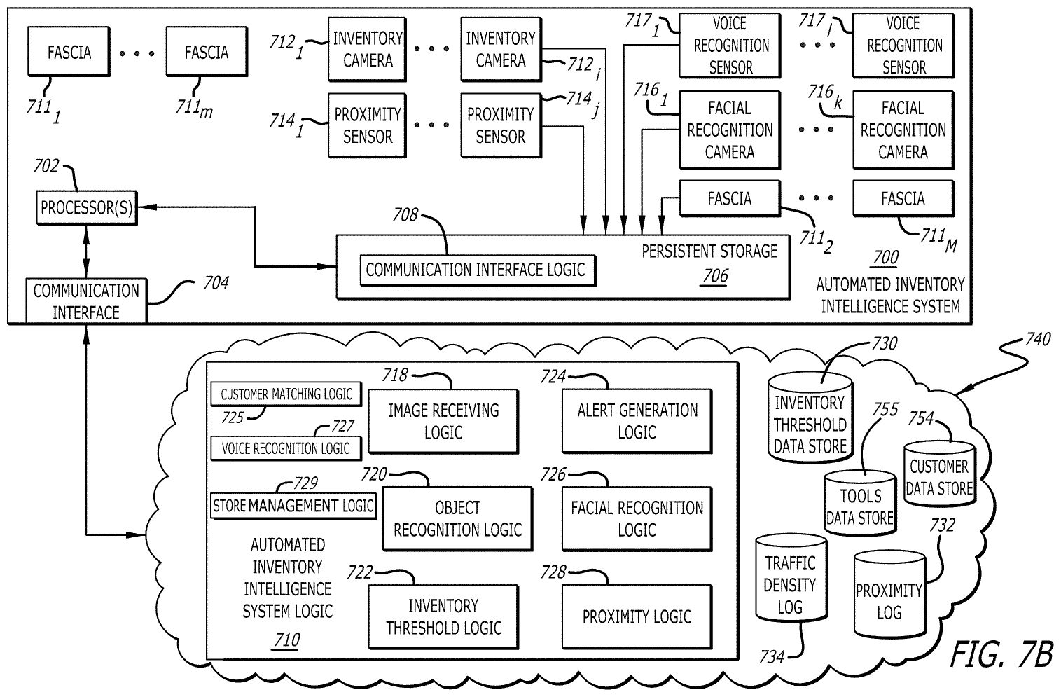

Referring to FIG. 7A, an exemplary embodiment of a first logical representation of the automated inventory intelligence system of FIG. 1 is shown in accordance with some embodiments. In many embodiments, the automated inventory intelligence system 700, may include one or more processors 702 that are coupled to a communication interface 704. The communication interface 704, in combination with a communication interface logic 708, enables communications with external network devices and/or other network appliances transmit and receive data. According to one embodiment of the disclosure, the communication interface 704 may be implemented as a physical interface including one or more ports for wired connectors. Additionally, or in the alternative, the communication interface 704 may be implemented with one or more radio units for supporting wireless communications with other electronic devices. The communication interface logic 708 may include logic for performing operations of receiving and transmitting data via the communication interface 704 to enable communication between the automated inventory intelligence system 700 and network devices via a network (e.g., the internet) and/or cloud computing services, not shown.

The processor(s) 702 is further coupled to a persistent storage 706. According to one embodiment of the disclosure, the persistent storage 706 may store logic as software modules includes an automated inventory intelligence system logic 710 and the communication interface logic 708. The operations of these software modules, upon execution by the processor(s) 702, are described above. Of course, it is contemplated that some or all of this logic may be implemented as hardware, and if so, such logic could be implemented separately from each other.

Additionally, the automated inventory intelligence system 700 may include hardware components such as fascia 711₁-711ₘ (wherein m≥1), inventory cameras 712₁-712ᵢ (wherein i≥1), proximity sensors 714₁-714ⱼ (wherein j≥1), and facial recognition cameras 716₁-716ₖ (wherein k≥1), and/or voice recognition sensors 717₁-717ₗ (wherein l≥1). For the purpose of clarity, couplings, i.e., communication paths, are not illustrated between the processor(s) 702 and the fascia 711₁-711ₘ, the inventory cameras 712₁-712ᵢ, the proximity sensors 714₁-714ⱼ, the facial recognition cameras 716₁-716ₖ, and/or the voice recognition sensors 717₁-717ₗ (wherein l≥1); however such couplings may be direct or indirect and configured to allow for the provision of instructions from the automated inventory intelligence system logic 710 to such components.

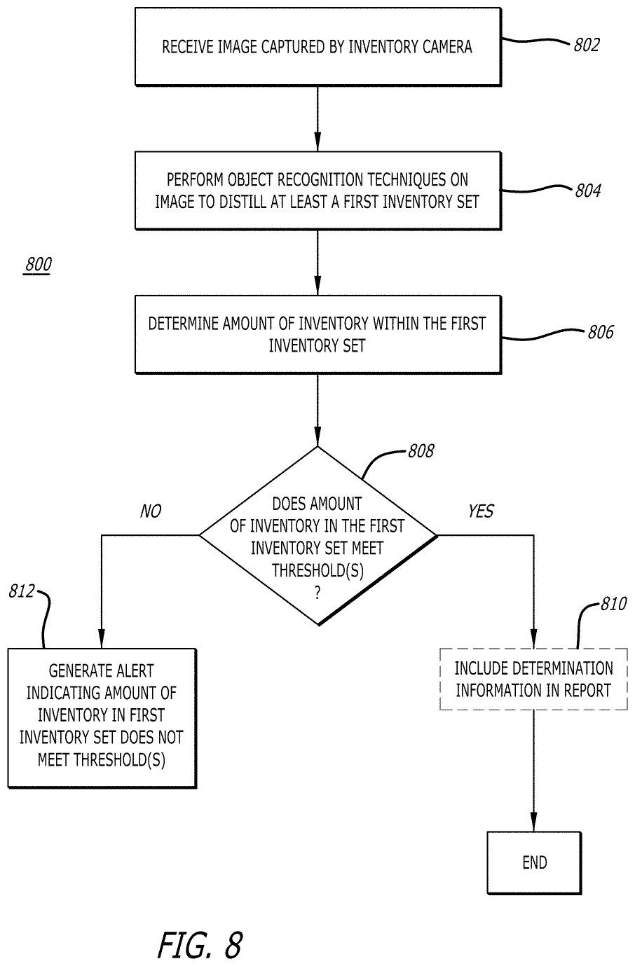

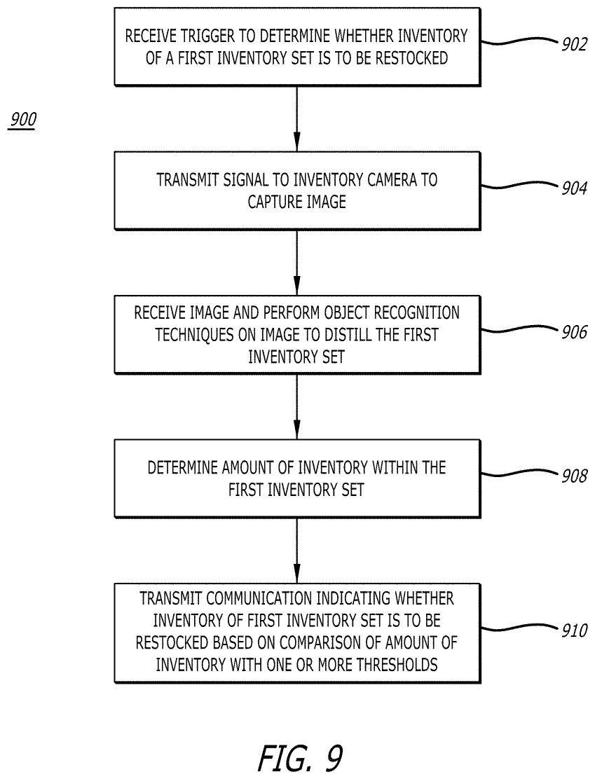

Each of the inventory cameras 712₁-712₁, the proximity sensors 714₁-714ⱼ, the facial recognition cameras 716₁-716ₖ, and/or the voice recognition sensors 717₁-717ₗ may be configured to capture images and/or voice samples, e.g., at predetermined time intervals or upon a triggering event, and transmit the images to the persistent storage 706. The automated inventory intelligence system logic 710 may, upon execution by the processor(s) 702, perform operations to analyze the images. Specifically, the automated inventory intelligence system logic 710 includes an image receiving logic 718, an object recognition logic 720, an inventory threshold logic 722, an alert generation logic 724, a customer matching logic 725, a facial recognition logic 726, a voice recognition logic 727, a proximity logic 728, and a store management logic 729 (or may be referred to as a smart store management tool, module, device, etc.). As will be discussed in further detail below with respect to FIGS. 8-9, the image receiving logic 718 can be configured to, upon execution by the processor(s) 702, perform operations to receive a plurality of images from a sensor, such as the inventory cameras 712₁-712₁. In some embodiments, the image receiving logic 718 may receive a trigger, such as a request for a determination as to whether an inventory set needs to be restocked, and request an image be captured by one or more of the inventory cameras 712₁-712ᵢ.

The object recognition logic 720 is configured to, upon execution by the processor(s) 702, perform operations to analyze an image received by an inventory camera 712₁-712ᵢ, including object recognition techniques. In some embodiments, the object recognition techniques may include the use of machine learning, predetermined rule sets and/or deep convolutional neural networks. The object recognition logic 720 may be configured to identify one or more inventory sets within an image and determine an amount of each product within the inventory set. In addition, the object recognition logic 720 may identify a percentage, numerical determination, or other equivalent figure that indicates how much of the inventory set remains on the shelf (i.e., stocked) relative to an initial amount (e.g., based on analysis and comparison with an earlier image and/or retrieval of an initial amount predetermined and stored in a data store, such as the inventory threshold data store 730).

The inventory threshold logic 722 is configured to, upon execution by the processor(s) 702, perform operations to retrieve one or more predetermined thresholds and determine whether the inventory set needs to be restocked. A plurality of predetermined holds, which may be stored in the inventory threshold data store 730, may be utilized in a single embodiment. For example, a first threshold may be used to determine whether the inventory set needs to be stocked and an alert transmitted to, for example, a retail employee (e.g., at least a first amount of the initial inventory set has been removed). In addition, a second threshold may be used to determine whether a product delivery person needs to deliver more of the corresponding product to the retailer (e.g., indicating at least a second amount of the initial inventory set has been removed, the second amount greater than the first amount). In such an embodiment, when the second threshold is met, alerts may be transmitted to both a retail employee and a product delivery person.

The alert generation logic 724 can be configured to, upon execution by the processor(s) 702, perform operations to generate alerts according to determinations made by, for example, the object recognition logic 720 and the inventory threshold logic 722. In certain embodiments, the alerts may take any form such as a digital communication transmitted to one or more electronic devices, and/or an audio/visual cue in proximity to the shelf on which the inventory set is stocked, etc.

In most embodiments, the customer matching logic 725 may be utilized for a variety of operations including, but not limited to, determining trends of the customers or gathering data related to the customers based on ethnicity, age, gender, time of visit, geographic location of the store, and so on. Based on additional analysis, the automated inventory intelligence system logic 710 may determine trends in accordance with a variety of factors including, but not limited to, graphics displayed by the automated inventory intelligence system 700, sales, time of day, time of the year, day of the week, etc. The customer matching logic 725 (in conjunction with the facial and/or voice recognition logics 726-727 in some embodiments) may be utilized to access customer information and/or accounts within a customer data store 754, to identify a customer recognized within a store based on at least one or more of the captured images and voice samples, to match the identified customer with a customer account associated with the identified customer, and/or to respectively authorize a sale of one or more products purchased by the identified customer based on payment information associated with the customer account. Any customer related data generated during shopping, such as any facial and/or voice recognition data (e.g., training phrases, spoken user passwords, payment information associated with any of the particular customers), may be added to the customer data store 754 and associated with a specific customer account or anonymized and stored for future analysis.

Customer matching may be accomplished utilizing other customer and inventory logics. Matching and authenticating may also be accomplished through the utilizing data received from a customer's mobile computing device in communication with the automated inventory intelligence system 700. By way of a non-limiting example, a customer may enter a store with a mobile phone that is loaded with an application that may create a data connection with the automated inventory intelligence system 700. Upon entering the store, the application may utilize GPS data to determine that the customer is within a store and transmits the data to such system 700. Based upon this data, the automated inventory intelligence system 700 may determine that a particular customer determined to be within the shopping area is the customer associated with the particular customer account. Data regarding the customer's age, height, etc. may be utilized to further match a recognized customer with an account associated with the customer, which may be also utilized to determine whether the recognized customer is associated with payment information that may allow the recognized customer with expedited purchases of products in the retail environment.

Upon matching the customer, all relevant data may be associated between the customer detected within the shopping area, and the customer account info that has been derived. In certain embodiments, the relevant data may include demographics data, shopping history/patterns, age verification data, and/or payment/preauthorization authentication rules which may be associated with an authorized method of payment the customer has set up in their account.

The facial recognition logic 726 may be configured to, upon execution by the processor(s) 702, perform operations to analyze images received by the image receiving logic 718 from the facial recognition cameras 716₁-716ₖ. In some embodiments, the facial recognition logic 726 may look to determine trends in customers based on ethnicity, age, gender, time of visit, geographic location of the store, etc., and, based on additional analysis, the automated inventory intelligence system logic 710 may determine trends in accordance with graphics displayed by the automated inventory intelligence system 700, sales, time of day, time of the year, day of the week, etc. Facial recognition logic 726 may also be able to generate data relating to the overall traffic associated with the facial recognition cameras 716₁-716ₖ. This can be generated directly based on the number of faces (unique and non-unique) that are processed within a given time period. This data can be stored within the persistent storage 706 within a traffic density log 734.

The voice recognition logic 727 may be configured to receive one or more voice samples of a retail customer captured by one or more microphones or audio devices, such as the microphones located within the inventory cameras 712₁-712₁, the proximity sensors 714₁-714ⱼ, the facial recognition cameras 716₁-716ₖ, and/or the voice recognition sensors 717₁-717ₖ. Furthermore, upon receiving the voice sample(s), the voice recognition logic 727 (or one or more other logics, such as the image receiving logic 718, the object recognition logic 720, the facial recognition logic 726, and so on) of the automated inventory intelligence system logic 710 may perform processing operations on the captured voice samples to analyze the one or more different captured voice samples of the retail customer. For example, the voice recognition logic 727 of the automated inventory intelligence system logic 710 may operate in combination with the facial recognition logic 726 upon the retail customer speaking a training phrase or a spoken user password that may be captured by the one or more microphones, where the voice recognition logic 727 may receive the multiple captured voice samples by way of a multiplicity of microphones that are coupled with a shelving unit, and where the microphones may be arranged into an advantageous microphone (or audio) geometry for capturing and identifying the voice of the retail customer.

The proximity logic 728 can be configured to, upon execution by the processor(s) 702, perform operations to analyze images received by, for example, the image receiving logic 718 from the proximity sensors 714₁-714ⱼ. In some embodiments, the proximity logic 728 may determine when a customer is within a particular distance threshold from the shelving unit on which the inventory set is stocked and transmit a communication (e.g., instruction or command) to the change the graphics displayed on the fascia, e.g., such as the fascia 711₁-711ₘ. Data related to the proximity, and therefore the potential effectiveness of an advertisement, may be stored within a proximity log 732. In this way, data may be provided that can be tracked with particular displays, products, and/or advertising campaigns.

In many embodiments, as described herein, the store management logic 729 may be configured (or used) as a smart store management tool that may enables users to design and stock an entire retail environment, such as a retail store or the like. The store management logic 729 may include a store builder that enables the user to use familiar designing and/or building techniques that may be used to create a variety of layouts of the entire retail store, as well as organize locations and maintain inventory of various shelving units, gondolas, inventory products, and so on within the store. The store management logic 729 may include a whole-store view tool that may be configured to show locations and current stock of inventory within the store and enables the users to view the current status of any inventory products at any specific locations within the store. The store management logic 729 may include an inventory analysis view tool that may be configured to show the locations and current stock of any inventory products on a specific shelving unit, gondola, shelf, and so on, that is selected by the users via the whole-store view tool. Additionally, the store management logic 729 may be configured (in conjunction with any other logics described herein, in some embodiments) to utilize data stored in a tools data store 755, which may include, but is not limited to, one or more building tools, user interfaces, designing techniques, management data, store data, and so on.

For example, the store management logic 729 may be configured as a smart management tool for intelligently managing and designing inventory products within a retail environment. In some embodiments, the store management logic 729 may include a plurality of tools such as a builder tool configured to allow a user to use one or more designing technique tools, where the one or more designing technique tools are configured to create a plurality of layout designs of the store. The available user tools may also include a whole view tool configured to generate one or more location views of one or more gondolas and one or more shelving units in the store. The whole view tool may also be configured to generate one or more current stock of inventory lists of the inventory products that are located in the one or more gondolas and shelving units in the store. Another available user tool includes an inventory analysis view tool configured to generate one or more locations and current stock of inventory views of any of the one or more gondolas and shelving units in the store, where the one or more generated locations and current stock of inventory views is selected by the users via the whole view tool.

Referring to FIG. 7B, an exemplary embodiment of a second logical representation of the automated inventory intelligence system of FIG. 1 is shown in accordance with some embodiments. The illustration of FIG. 7B provides a second embodiment of the automated inventory intelligence system 700 in which the automated inventory intelligence system logic 710 of FIG. 7A resides in cloud computing services 740. In such an embodiment, each of the fascia 711₁-711ₘ, the inventory cameras 712₁-712ᵢ, the proximity sensors 714₁-714ⱼ, and the facial recognition cameras 716₁-716ₖ may be configured to capture images, and each of the voice recognition sensors 717₁-717ₗ may be configured to capture voice samples, where the captured images and/or voice samples are then transmitted, via the communication interface 704, to the automated inventory intelligence system logic 710 in the cloud computing services 740. The automated inventory intelligence system logic 710, upon execution via the cloud computing services 740, perform operations to analyze the images and/or voice samples. It should be understood that the one or more devices, logics, and data stores of the automated inventory intelligence system 700 and the automated inventory intelligence system logic 710 depicted in FIG. 7B may be substantially similar to the respective one or more devices, logics, and data stores of the automated inventory intelligence system 700 and the automated inventory intelligence system logic 710 depicted in FIG. 7A.

Processor(s) 702 can represent a single processor or multiple processors with a single processor core or multiple processor cores included therein. Processor(s) 702 can represent one or more general-purpose processors such as a microprocessor, a central processing unit (“CPU”), or the like. More particularly, processor(s) 702 may be a complex instruction set computing (“CISC”) microprocessor, reduced instruction set computing (“RISC”) microprocessor, very long instruction word (“VLIW”) microprocessor, or processor implementing other instruction sets, or processors implementing a combination of instruction sets. Processor(s) 702 can also be one or more special-purpose processors such as an application specific integrated circuit (“ASIC”), a field programmable gate array (“FPGA”), a digital signal processor (“DSP”), a network processor, a graphics processor, a network processor, a communications processor, a cryptographic processor, a co-processor, an embedded processor, or any other type of logic capable of processing instructions. Processor(s) 702 can be configured to execute instructions for performing the operations and steps discussed herein.

Persistent storage 706 can include one or more volatile storage (or memory) devices, such as random access memory (“RAM”), dynamic RAM (“DRAM”), synchronous DRAM (“SDRAM”), static RAM (“SRAM”), or other types of storage devices. Persistent storage 706 can store information including sequences of instructions that are executed by the processor(s) 702, or any other device. For example, executable code and/or data of a variety of operating systems, device drivers, firmware (e.g., input output basic system or BIOS), and/or applications may be loaded in persistent storage 706 and executed by the processor(s) 702. An operating system may be any kind of operating systems, such as, for example, Windows® operating system from Microsoft®, Mac OS®/iOS® from Apple, Android® from Google®, Linux®, Unix®, or other real-time or embedded operating systems such as VxWorks.

Some portions of the description provided herein have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures may be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals-such as carrier waves, infrared signals, digital signals).

The processes or methods depicted in the figures may be performed by processing logic that includes hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

4. Inventory Monitoring Methodology

Referring now to FIG. 8 with additional reference to FIGS. 7A-7B, a flowchart illustrating an exemplary method for analyzing, by the automated inventory intelligence system logic 710 of FIGS. 7A-7B, an image of inventory to determine whether the inventory is to be restocked is shown in accordance with some embodiments. Each block illustrated in FIG. 8 represents an operation performed in the method 800 of analyzing an image of inventory to determine whether the inventory is to be restocked. Herein, the method 800 starts when the image receiving logic 718 of the automated inventory intelligence system logic 710 receives an image captured by an inventory camera, e.g., the inventory camera 712₁ (block 802).

Upon receiving the image, the object recognition logic 720 of the automated inventory intelligence system logic 710 performs processing on the image including one or more object recognition techniques to distill at least a first inventory set (block 804). For example, the object recognition logic 720 may perform operations including, but not limited or restricted to, identification of objects of interest within the image, quantification of objects of interest within the image, depth determination of object of interest within the image, and/or pattern recognition of at least portions of items of interest within the image in order to differentiate inventory sets. For example, as illustrated in FIG. 5, the object recognition logic 720 may distill at least two inventory sets from the image 500 including the first inventory portion 508 and second inventory portion 510. The object recognition techniques may utilize deep convolutional neural networks, machine learning techniques and/or predetermined rule sets. Object recognition techniques may also be referred to as image recognition and/or computer vision.

Following the performance of the object recognition techniques and the distilling of at least the first inventory set, object recognition logic 720 determines the amount of inventory within the first inventory set (block 806). As discussed in further detail below with respect to thresholds, the amount of inventory may refer to a specific number of items (e.g., 16 2 L soda bottles remain) or a percentage/ratio (e.g., 50% of the 2 L soda bottles remain or ½ of the 2 L soda bottles remain).

As discussed below, the number of items initially stocked may be predetermined and stored in the inventory threshold data store 730. Additionally, or in the alternative, the object recognition logic 720 may determine or estimate the number of items to fill the shelf space provided for the first inventory set (e.g., estimate the shelf space based on the location of the first inventory set relative to the edges of the shelf and other inventory sets also located on the shelf).

Subsequent to the determination of the amount of inventory within the first inventory set, the inventory threshold logic 722 can determine whether the amount of inventory set meets a predetermined threshold (block 808). In certain embodiments, the thresholds may be stored in and retrieved from the inventory threshold data store 730. In some embodiments, a single predetermined threshold may be utilized for all inventory sets, e.g., a percentage of inventory remaining on the shelf. In one embodiment, the object recognition logic 720 may determine the percentage of inventory remaining by retrieving a predetermined number representing the initial inventory (e.g., a number items initially stocked) and determining the ratio between the initial inventory and the current inventory. Such a predetermined number may also be stored in the inventory threshold data store 730 and stored according to the inventory set and the retailer or retail location (as one retailer may not have the same amount of space to stock the inventory set as a second retailer). The predetermined number may be dynamically adjustable by, for example, a retail employee when the inventory set is restocked and/or the inventory set is moved from a first location to a second location.

In other embodiments, a predetermined threshold (e.g., either a percentage or a number) may be stored for one or more inventory sets. For example, a first threshold may correspond to a first inventory set, such as 2 L bottles of a first soda, and a second threshold (different than the first threshold) may correspond to a second inventory set, such as 12 oz. bottles of the first soda. Additionally, thresholds may be dynamically adjusted for various reasons including, but not limited to, sale prices, local stock levels, sales history, promotional campaigns, etc.

When the inventory threshold logic 722 determines that the amount of inventory of the first inventory set meets or exceeds the predetermined threshold (yes at block 808), the alert generation logic 724 may optionally generate a report, or add information to an existing report (such as a log), indicating that a determination was made that the first inventory set did not need to be restocked (block 810). For example, one or more of the following may be included in a log: a time stamp, an indication or identifier of the inventory camera that captured the image, the image, an indication or identifier of the first inventory set (as well as other inventory sets recognized), an indication of the determination not to restock, etc.

When the inventory threshold logic 722 determines that the amount of inventory of the first inventory set does not at least meet the predetermined threshold (no at block 808), the alert generation logic 724 may generate an alert (and/or a report) indicating that the first inventory set is to be restocked (block 812). The alert may take many forms including, but not limited or restricted to, a text message, an email, or any other digitally transmitted audio/visual indication (e.g., message transmitted via Bluetooth®). Additionally, or in the alternative, the alert may include a visual indication located proximate to the shelf on which the first inventory set is stocked (e.g., a light on or near the relevant shelf or a light on the corresponding cabinet display top). The alert may include information such as an identifier of the first inventory set, an indicator identifying the location of the first inventory set within the retailer or retail location (e.g., a map of the retailer's space and an indicator of the relevant shelf on the map or an aisle number), an amount of inventory to restock (e.g., a particular number or percentage, the determination of which is discussed above), the image of the first inventory set, etc. The alert may be transmitted to one or more of: an electronic device at the retailer or retail location (e.g., a dedicated tablet in the back of the retailer), an electronic device of a specific employee, an electronic device of a distributor/product delivery person, etc. In some embodiments, the determination of what information to include and to what electronic devices to transmit the alert may be based on a predetermined rule set (which may also be stored in the inventory threshold data store 730). For example, the predetermined rule set may include a set of thresholds such that a first, lower threshold indicates an alert is to be sent to a retail employee, while a second, higher threshold indicates the alert is also to be sent to a distributor/product delivery person (i.e., when inventory is very low, send alert to distributor/product delivery person). In some embodiments, the alert generation logic 724 may access a data store, not shown, which includes information as to the total amount of the product comprising the first inventory set at a particular retailer or retail location (e.g., amount of the product stocked and also located in the back of the retailer or retail location, which may be dynamically updated in real-time based on product sales information obtained when a customer makes a purchase).

Referring now to FIG. 9, a flowchart illustrating an exemplary method for analyzing, by the automated inventory intelligence system logic of FIGS. 7A-7B, an image of inventory to determine whether the inventory is to be restocked based on a triggering event is shown in accordance with some embodiments. Each block illustrated in FIG. 9 represents an operation performed in the method 900 of analyzing an image of inventory to determine whether the inventory is to be restocked based on a triggering event. Herein, in accordance with certain embodiments, the method 900 can start when the image receiving logic 718 of the automated inventory intelligence system logic 710 receives a trigger to determine whether inventory of a first inventory set is to be restocked (block 902). A trigger may take various including a communication from a proximity sensors 714₁-714ⱼ, from a facial recognition camera 716₁-716ₖ, a retail employee and/or a product delivery person. In addition, a trigger be received automatically at predetermined intervals (e.g., a pull system such that the inventory cameras 712₁-712ᵢ are activated upon an instruction from the image receiving logic 718).

In response to receiving a trigger, the image receiving logic 718 can transmit a signal or other communication to an inventory camera 712₁-712ᵢ monitoring the first inventory set identified in the trigger (e.g., the inventory configured to capture an image of the first inventory set) (block 904). The image receiving logic 718 may determine one or more inventory cameras of the inventory cameras 712₁-712ᵢ that are to capture an image. In one embodiment, the received trigger include have an indication of a particular inventory set (e.g., 2 L bottles of a first soda). The image receiving logic 718 may determine the location of the particular inventory set in the retail location and determine the inventory camera 712₁-712ᵢ that is configured/positioned to capture an image of the identified location. For example, a data store of the automated inventory intelligence system 700, not shown, may be configured to store data indicating pairings of: {inventory set, retail location}. Based on the stored pairing, which may be dynamically adjustable based on restocking of shelves, the image receiving logic 718 may determine the retail location of the inventory. In addition, the data store may also be configured to store pairings of: {retail location, inventory camera}. Therefore, based on the determined retail location, the image receiving logic 718 may determine the inventory camera 712₁-712ᵢ that is positioned to capture an image of the retail location at which the particular inventory set is stocked. Based on this determination, the image receiving logic 718 may transmit a signal to the identified inventory camera with the instruction to capture an image.

Subsequent to the transmission of the signal to the relevant inventory camera, the image receiving logic 718 can receive an imaged captured by the relevant inventory camera (block 906). Following the receipt of the image, the automated inventory intelligence system logic 710 determines an amount of inventory within the first inventory set as discussed in FIG. 8 (block 908). Further, the automated inventory intelligence system logic 710 transmits a communication indicating whether inventory of the first inventory set is to be restocked based on a comparison of the amount of inventory of the first inventory set remaining with one or more inventory thresholds as discussed in FIG. 8 (block 910).

5. Proximity Sensor

a. Proximity Sensor Architecture

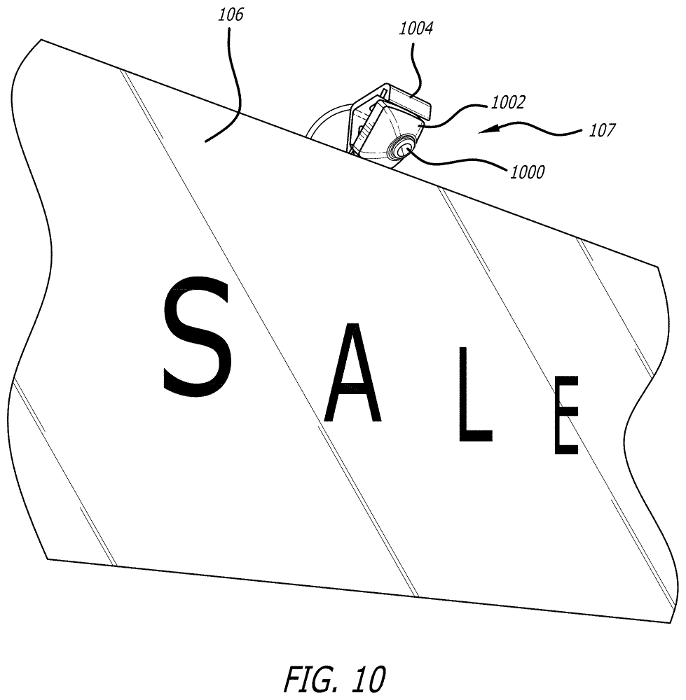

Referring now to FIG. 10, an exemplary embodiment of the proximity sensor positioned on a cabinet display top of the automated inventory intelligence system of FIG. 1 is shown in accordance with some embodiments. In particular, FIG. 10 illustrates one embodiment in which the proximity camera 107 is a camera (“proximity camera 107”); however, the disclosure is not intended to be so limited. Instead, the proximity camera 107 may be any sensor configured to detect objects within a predetermined proximity region, e.g., without any physical contact with the objects. For example, a proximity region may be a geo-fence, e.g., a virtual perimeter for a geographical area. Examples of alternative proximity sensors may include, but are not limited or restricted to, electromagnetic sensors, infrared sensors, and optical sensors. In addition, in certain embodiments, capacitive proximity sensors, photoelectric proximity sensors, and/or inductive proximity sensors may be used.

The proximity camera 107 of FIG. 10 is configured to couple to the cabinet display top 106 via a mount 1004 and includes a lens 1000 and a housing 1002 of proximity camera. In one embodiment, the proximity camera 107 may be the same camera as the inventory camera 210 as seen in, for example, FIG. 2C, or an equivalent model. In one embodiment, the proximity camera 107 may have a viewing angle of approximately 180° (degrees) and is capable of monitoring a larger portion of the store environment, particularly, the geographic region in front of the shelving unit to which the proximity camera 107 is coupled.

Although illustrated as being positioned on top of the cabinet display top 106, the proximity camera 107 may be coupled to a side or the bottom of the cabinet display top 106. In addition, although not shown, the proximity camera 107 may be integrated directly into the cabinet display top 106. In addition, the proximity camera 107 may be positioned at any location on the cabinet display top 106, e.g., the middle, toward either end, etc.

b. Proximity Region Analysis and Graphic Displays

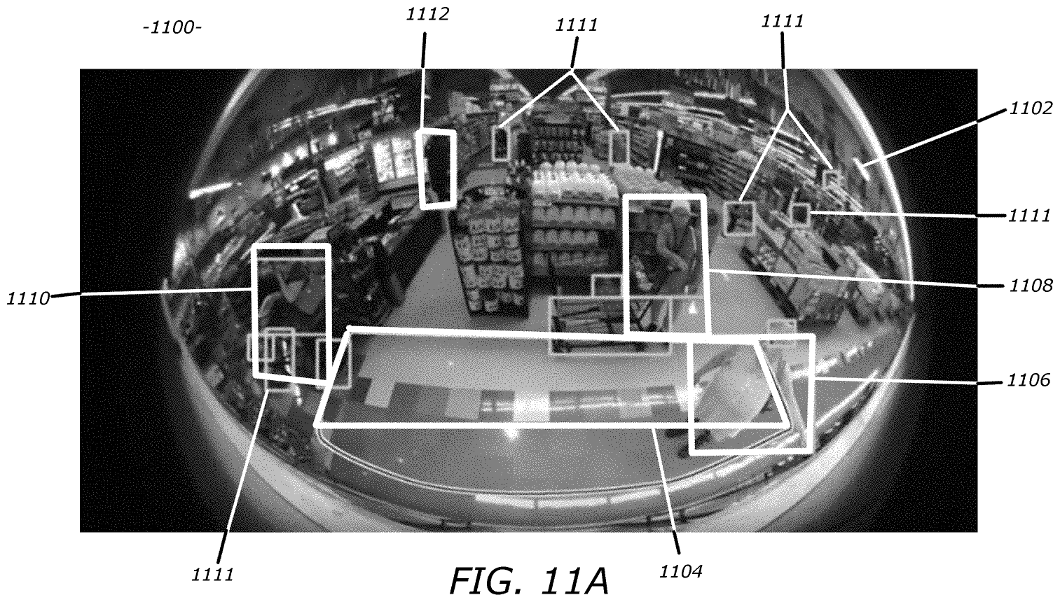

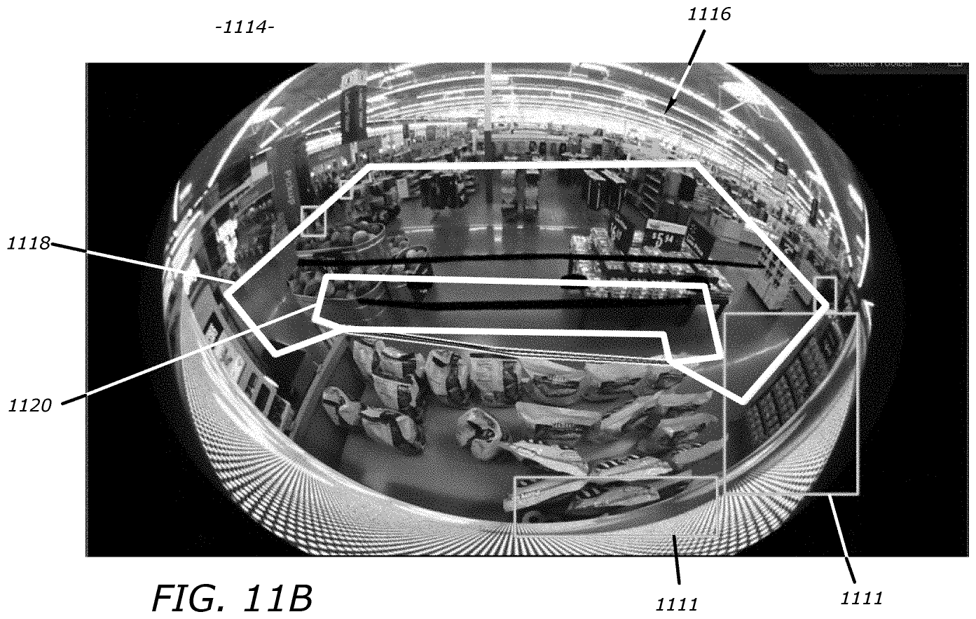

Referring to FIG. 11A, a first illustration of an image captured by the proximity sensor of the automated inventory intelligence system of FIG. 1 is shown in accordance with some embodiments. The image 1100 provides one exemplary perspective from the proximity camera 107 of FIGS. 1 and 10. The image 1100 provides an illustration of a store environment 1102 including a view of numerous store aisles as well as a geographic region proximate the shelving unit to which the automated inventory intelligence system (and hence the proximity camera 107) is coupled. For example and as shown in FIG. 11A, the proximity camera 107 is configured to capture the image 1100, which provides a capture of objects in front of, and approaching, the front of the shelving unit.

In particular, the image 1100 includes an image capture, e.g., a picture, of a region including a first proximity region 1104. Additionally, the image 110 captures a first shopper 1106 at least partially within the first proximity region 1104, and shoppers 1108, 1110 and 1112 outside of the first proximity region 1104. In some embodiments, the image 1100 may capture additional objects 1111. In one embodiment, the proximity logic 728, as seen in FIGS. 7A-7B, is communicatively coupled to the proximity camera 107 and may determine the graphic(s) to be displayed on the fascia, according to the location of one or more objects detected in the captured image 1100. Specifically, upon receipt of the image 1100 from the proximity camera 107, the proximity logic 728 may be configured to detect objects within the image 1100 and determine whether each detected object is within a proximity region. In some embodiments, the proximity logic 728 may be configured to detect objects with one or more proximity regions.

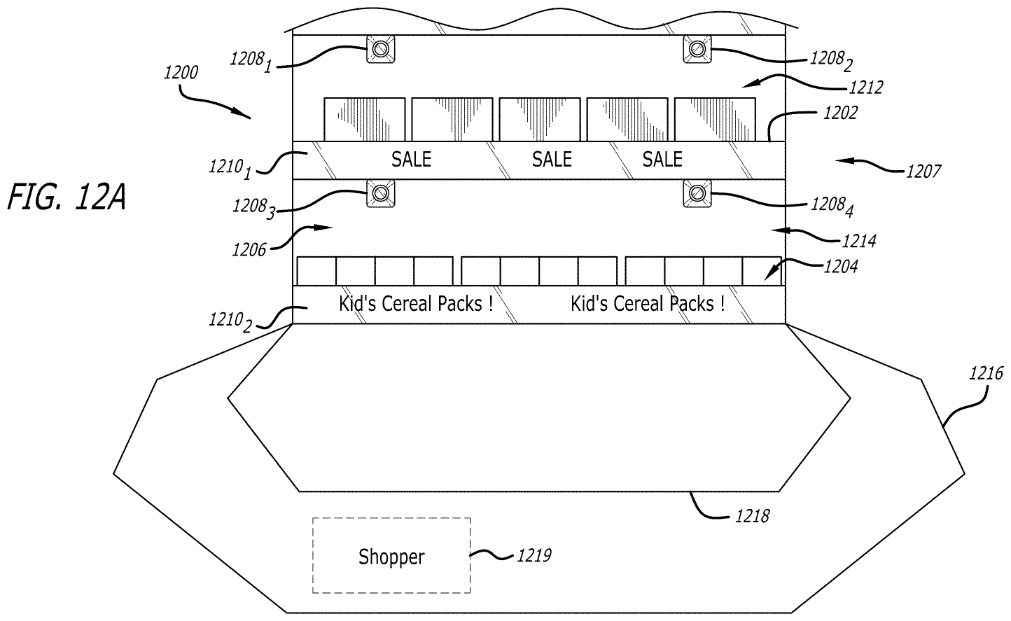

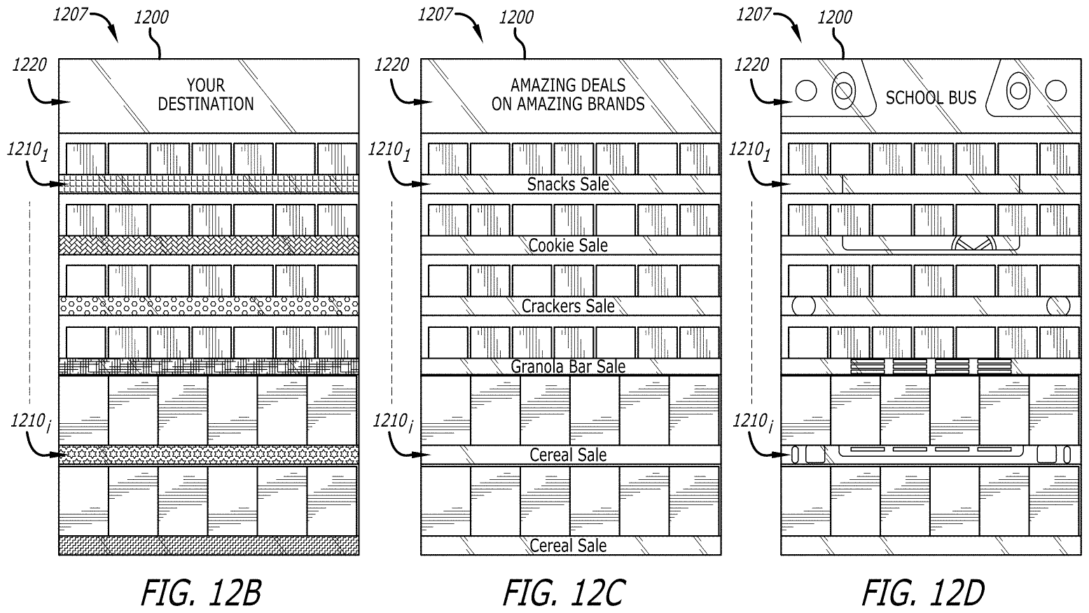

For example, as shown in FIG. 11A, a first proximity region 1104 may be utilized such that when an object is detected and determined to be within the first proximity region 1104, the proximity logic 728 may transmit one or more instructions causing the automated inventory intelligence system to display a first graphic (e.g., product information) on its fascia, e.g., the fascia 108₁-108₄, as well as the cabinet display top 106. Subsequently, when objects are no longer detected within the proximity region, the proximity logic 728 may transmit one or more instructions causing the automated inventory intelligence system to display a second graphic (e.g., a promotion or other immersive graphic) on the fascia 108₁-108₄ and/or the cabinet display top 106. As will be discussed in further detail below with respect to FIGS. 11B and 12A, the proximity logic 728 may be configured to detect objects and determine whether each object is within one of a plurality of proximity regions such that the automated inventory intelligence system causes the display of various graphics depending on in which region each object is determined to be.

Referring to FIG. 11B, a second illustration of an image captured by the proximity sensor of the automated inventory intelligence system of FIG. 1 is shown in accordance with some embodiments. The image 1114 captured by the proximity camera 107 illustrates the proximity logic 728 being configured to detect objects within a plurality of proximity regions, e.g., the first proximity region 1118 and the second proximity region 1120 within the store environment 1116. As will discussed in more detail with respect to FIGS. 12A-12D, the proximity logic 728 may provide instructions that cause the corresponding fascia to display varying graphics depending on whether objects are detected in the first proximity region 1118 and/or the second proximity region 1120. In a variety of embodiments, the second proximity region 1120 may comprise a smaller region compared to the first proximity region 1118 and be located closer to the shelving unit compared to the first proximity region 1118. However, many embodiments may also have first and second proximity regions 1118, 1120 separate and non-overlapping (or a mix of both).

Referring now to FIG. 12A, an exemplary illustration of a plurality of proximity regions based on one configuration of a proximity sensor of an automated inventory intelligence system is shown in accordance with some embodiments. The illustration of FIG. 12A provides an illustration of a first proximity region 1216 and a second proximity region 1218 partially surrounding the shelving unit 1200, with a shopper 1219 located within the first proximity region 1216. The shelving unit 1200, being similar in this embodiment to the shelving unit 102 of FIG. 1, includes a first shelf 1202 and a second shelf 1204 as well as a back component 1206. The shelving unit 1200 may be coupled to the automated inventory intelligence system 1207, which is shown to include inventory cameras 1208₁-1208₄, and fascia 1210₁-1210₂. The automated inventory intelligence system 1207 of the depicted embodiment may be closely equivalent to the automated inventory intelligence system 100 of FIG. 1. Additionally, the shelving unit 1200 may be stocked with inventory such as a first inventory set 1212 and a second inventory set 1214. The first and second inventory sets 1212, 1214 may be monitored by the inventory cameras 1208₁-1208₄ as discussed above in accordance with at least FIGS. 1-5.

In some embodiments, the graphics displayed on the fascia 1210₁-1210₂ may be changed in accordance with instructions provided by the proximity logic 728 based on whether an object is detected in the first proximity region 1216 and/or the second proximity region 1218. For example, in certain embodiments, the proximity logic 728 may receive images captured by a proximity camera, such as the proximity camera 107, and perform object recognition techniques, e.g., such as those discussed above with respect to the images captured by the inventory cameras 110₁-110ᵢ. In other embodiments, the images captured by the proximity camera may be provided to the object recognition logic 720. Based on the detection of one or more objects in one or more of the first proximity region 1216 and/or the second proximity region 1218, the proximity logic 728 may cause the automated inventory intelligence system 1207 to change states, e.g., an immersive state, a promotion state, and a product information state. It should be noted that these are merely exemplary names and that an alternative naming convention may be utilized. Further, more or fewer states may be utilized by the proximity logic 728. For example, the image 1100 of FIG. 11A illustrates a scenario in which the proximity logic 728 may be configured with fewer than three states, e.g., two states.

As illustrated in FIG. 12A, the shopper 1219 has been detected as being located in the first proximity region 1216. Based on the detection of the shopper 1219 being located in the first proximity region 1216, the proximity logic 728 has caused the automated inventory intelligence system 1207 to enter into a “promotion state” such that the fascia 1210₁-1210₂ are configured to display a promotion graphic (e.g., “Sale!” and “Kids Cereal!”). In the embodiment illustrated in FIG. 12A, the proximity logic 728 may be configured with three possible states: (1) an immersive state triggered when no objects are detected in either of the first proximity region 1216 or the second proximity threshold 1218, wherein the fascia 1210₁-1210₂ are to display an immersive graphic; (2) a promotion state triggered when an object is detected in the first proximity region 1216 but no object detected in the second proximity region 1218, wherein the fascia 1210i-1210₂ are to display a promotion graphic; and (3) a promotion state triggered when an object is detected in the second proximity region 1218, wherein the fascia 1210₁-1210₂ are to display a product information graphic. Additional fascia, not shown, and/or the cabinet display top 1220 may also display graphics according to the state of the automated inventory intelligence system 1207. Embodiments of an automated inventory intelligence system 1207 in different states are discussed below and illustrated in FIGS. 12B-12D.

As is evident from the illustrations of FIGS. 12A-12D, one goal of the graphics displayed on the cabinet display top 1220 and/or the fascia 1210₁-1210₂ is to grab the attention of shoppers and prolong dwell time in front of the shelving unit 1200, which makes it more likely the shopper will purchase an item stocked on the shelving unit 1200. Specifically, the invention provides manufacturers and retailers the advantage of enabling point of sale marketing through dynamic video and animation.

The discussion of FIGS. 12B-12D will be in reference to FIG. 12A. Referring now to FIG. 12B, an exemplary illustration fascia of the automated inventory intelligence system 1207 displaying a first graphic while in a promotion state is shown in accordance with some embodiments. FIG. 12B illustrates the shelving unit 1200 of FIG. 12A coupled to the automated inventory intelligence system of FIG. 12A in a promotion state. The promotion state may correspond to the display of content-specific promotions graphics on one or more of the fascia 1210₁-1210ᵢ and cabinet display top 1220. In particular embodiments, the graphics displayed may be (i) specific to the items stocked on the shelving unit, (ii) specific to the brands having items stocked on the shelving unit, (iii) promotions and/or discounts specific to the items stocked on the shelving unit, etc. As is illustrated in FIG. 12B, the proximity logic 728 has provided instructions causing the fascia 1210₁-1210ᵢ to display promotional information, e.g., a promotion benefitting schools by virtue of purchasing cereal and returning a portion of the cereal box, which corresponds to the items, e.g., cereal, stocked on the shelving unit 1200.

Referring now to FIG. 12C provides an exemplary illustration fascia of the automated inventory intelligence system of FIG. 12A displaying a first graphic while in a product information state is shown in accordance with some embodiments. FIG. 12C illustrates the shelving unit 1200 of FIG. 12A coupled to the automated inventory intelligence system 1207 in a product information state. The product information state may correspond to the display of product specific information graphics, including pricing information, on one or more of the fascia 1210₁-1210ᵢ and cabinet display top 1220. In some embodiments, the product information state may include information similar to information displayed in the promotion state including discounts or promotions on particular items or with particular brands. As is illustrated in FIG. 12C, the proximity logic 728 has provided instructions causing the fascia 1210₁-1210ᵢ to display product information, e.g., pricing information for each of the items stocked on the shelving unit 1200.

Referring to FIG. 12D provides an exemplary illustration fascia of the automated inventory intelligence system 1207 displaying a first graphic while in an immersive state is shown in accordance with some embodiments. FIG. 12D illustrates the shelving unit 1200 of FIG. 12A coupled to the automated inventory intelligence system 1207 in an immersive state. The immersive state may correspond to the display of graphics which may span a plurality of the fascia 1210₁-1210ᵢ. The graphics displayed while the automated inventory intelligence system 1207 is in the immersive state are intended to grab the attention of shoppers not standing immediately in front of the shelving unit 1200. In some embodiments, the graphics displayed while the automated inventory intelligence system 1207 can be in the immersive state span from the cabinet display top 1220 and across each of the fascia 1210₁-1210ᵢ. For example, as is illustrated in FIG. 12D, the proximity logic 728 has provided instructions causing the cabinet display top 1220 and the fascia 1210₁-1210ᵢ to display an immersive graphic, e.g., an animation of a school bus. In such an embodiment, the graphic may be animated wherein lights of the school bus may appear to flash and/or the school bus may appear to be approaching the edge of the shelving unit 1200 facing customers and the retail environment.

c. Proximity Region Detection Methodology

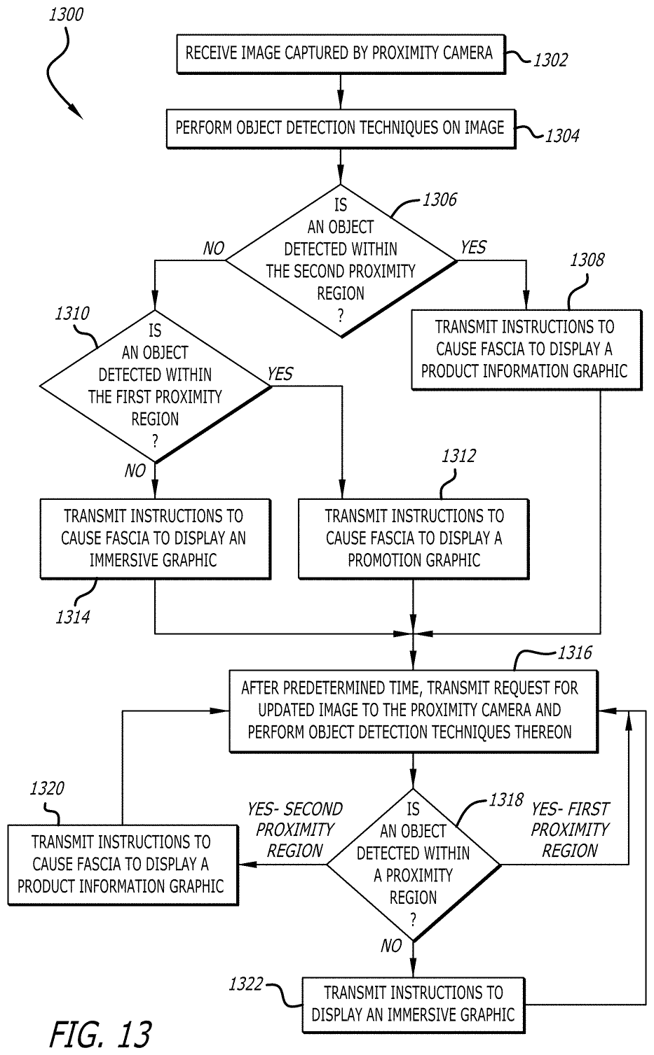

Referring to FIG. 13, an exemplary flowchart illustrating operations corresponding to detecting whether an object is located within one of a plurality of proximity regions performed by an automated inventory intelligence system is shown in accordance with some embodiments. Each block illustrated in FIG. 13 represents an operation performed in the method 1300 of detecting whether an object is located within one of a plurality of proximity regions performed by an automated inventory intelligence system. FIG. 13 will be discussed with reference to FIGS. 12A-12D. The method 1300 begins when an image captured by a proximity sensor, e.g., the proximity camera 107, is received (block 1302). Following receipt of the image from the proximity camera 107, object recognition techniques, as described above, can be performed on the image (block 1304).

Subsequent to the performance of object recognition techniques, a determination is made as to whether an object is detected within the second proximity region 1218 of FIG. 12A, i.e., a proximity region closest to the proximity camera 107 (block 1306). When an objected is detected within the second proximity region 1218, instructions are transmitted by the proximity logic 728 that are configured to cause fascia, e.g., the fascia 1210₁-1210ᵢ, and/or the cabinet display top 1220 to display a product information graphic (block 1308). The method 1300 then continues the operations discussed below with respect to FIG. 13.

When an objected is not detected within the second proximity region 1218, a determination is made as to whether an object is detected within the first proximity region 1216 of FIG. 12A, (block 1310). When an objected is detected within the first proximity region 1216 but not the second proximity region 1218, instructions are transmitted by the proximity logic 728 that are configured to cause fascia, e.g., the fascia 1210₁-1210ᵢ, and/or the cabinet display top 1220 to display a promotion graphic (block 1312). The method 1300 then continues the operations discussed below with respect to FIG. 13.

When an objected is not detected within the first proximity region 1216 or the second proximity region 1218, instructions are transmitted by the proximity logic 728 that are configured to cause fascia, e.g., the fascia 1210₁-1210ᵢ, and/or the cabinet display top 1220 to display an immersive graphic (block 1314). The method 1300 then continues the operations discussed below with respect to FIG. 13.

Referring now to FIG. 13, subsequent to the transmission of instructions to display a graphic on the fascia 1210₁-1210ᵢ, and/or the cabinet display top 1220, any of a product information graphic, a promotion graphic or an immersive graphic, the proximity logic 728 can stall for a predetermined amount of time. Following the expiration of the predetermined amount of time, the proximity logic 728 may transmit a request for an updated image to the proximity camera 107 and performs object recognition techniques on the received image (block 1316).

Subsequent to the performance of object recognition techniques, a determination is made as to whether an object is detected within a proximity region (block 1318). When an object is detected only in the first proximity region 1216, i.e., no change since the previous image was captured, no change is instituted to the graphic displayed on the fascia 1210₁-1210ᵢ, and/or the cabinet display top 1220 and the method 1300 returns to block 1316.

When an object is detected in the second proximity region 1218, instructions are transmitted by the proximity logic 728 that are configured to cause fascia, e.g., the fascia 1210₁-1210ᵢ, and/or the cabinet display top 1220 to display a product information graphic (block 1320) and the method 1300 returns to block 1316.

When no object is detected any proximity region, instructions can be transmitted by the proximity logic 728 that are configured to cause fascia, e.g., the fascia 1210₁-1210ᵢ, and/or the cabinet display top 1220 to display an immersive graphic (block 1322) and the method 1300 returns to block 1316.

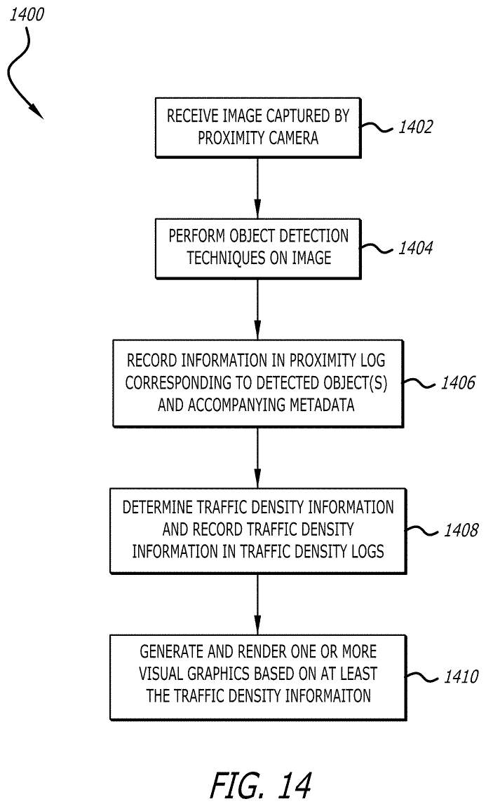

Referring to FIG. 14, an exemplary flowchart illustrating operations corresponding to detecting one or more objects in one or more of a plurality of proximity regions and generating activity logs performed by an automated inventory intelligence system is shown in accordance with some embodiments. Each block illustrated in FIG. 14 represents an operation performed in the method 1400 of detecting one or more objects in one or more of a plurality of proximity regions and generating activity logs performed by an automated inventory intelligence system. The method 1400 begins when an image captured by a proximity sensor, e.g., the proximity camera 107, is received by, e.g., the proximity logic 728 and/or the object recognition logic 720 (block 1402). Following receipt of the image from the proximity camera 107, object recognition techniques, as described above, are performed on the image (block 1404).

Upon completion of the object recognition techniques, information corresponding to the detected object(s) and accompanying metadata is recorded in a proximity log, e.g., the proximity log 732 of FIGS. 7A-7B (block 1406). Based on the information corresponding to the detected object(s) and the accompanying metadata, traffic density information can be determined, e.g., by the proximity logic 728, and recorded in a traffic density log, e.g., the traffic log 734 of FIGS. 7A-7B (block 1408). The traffic density information may include, but is not limited or restricted to, traffic density (of shoppers, employees, or a mix of either) over a given time period (broken down in time frames including by the hours of the day, days of the week, etc.), inventory on the corresponding unit during each time frame, the display on the fascia and/or the cabinet display top during each time frame, demographic data of each shopper, location of the retail location, location of the shelving unit within the retail location, an outdoor temperature at the retail location during a given time frame (e.g., exact, average, etc.), etc. In certain embodiments, the shelving unit may be able to differentiate shoppers from employees due to an identifying uniform/object (which can be parsed by the object detection techniques described above) or via a signal transmission (from, for example, employee cards/identification badges).

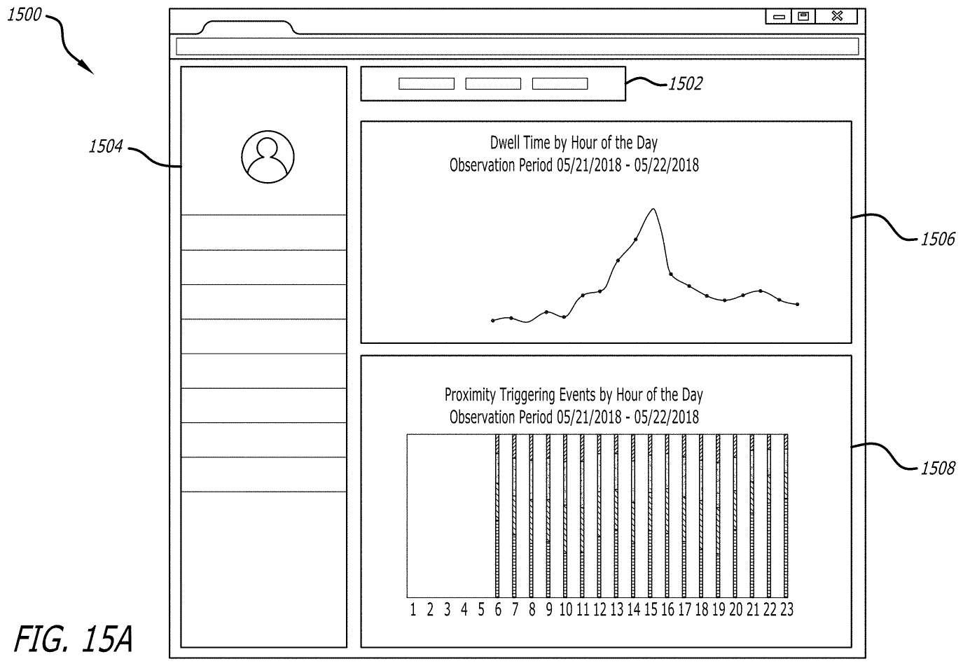

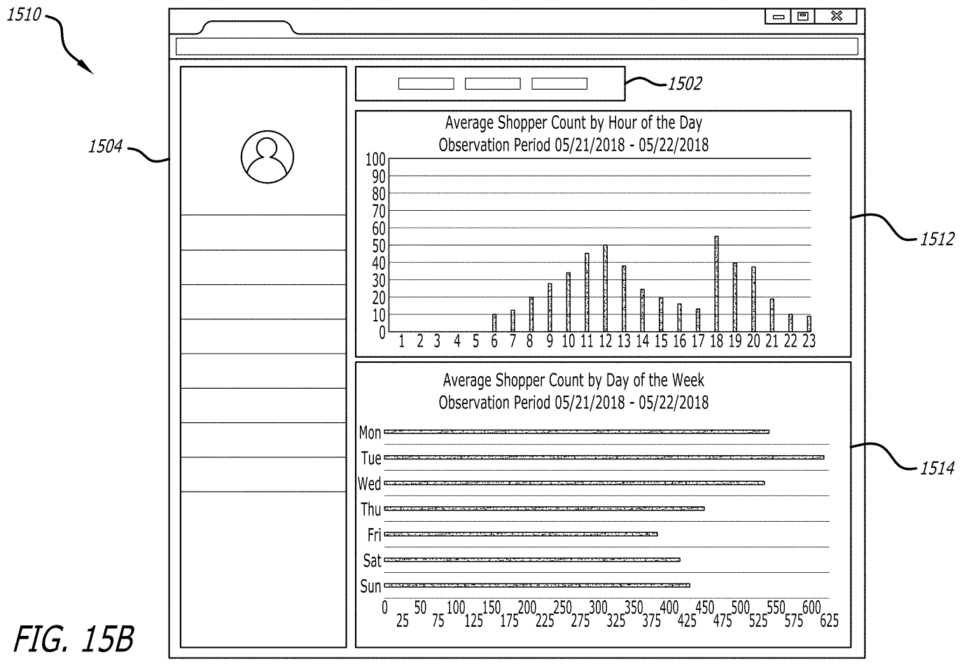

In addition, the proximity logic 728 and/or the alert generation logic 724 may generate and cause the rendering of one or more visual graphic displays based on at least in part the traffic density information (block 1410). Exemplary visual graphic displays are illustrated in FIGS. 15A-15B.

d. Visual Graphic Display of Traffic Density Information

Referring to FIG. 15A, an exemplary embodiment of a first user interface display screen produced by an automated inventory intelligence system, where the first user interface display screen provides an interactive dashboard is shown in accordance with some embodiments. The first user interface display screen 1500 generated by either the proximity logic 728 and/or the alert generation logic 724, and rendered by the alert generation logic 724 comprises a plurality of display areas including a top navigation panel 1502, a side navigation panel 1504, a first graphical display area 1506 and a second graphical display area 1508.

The top navigation panel 1502 may include graphic display elements, each configured to receive user input and cause performance of specific operations including filtering options and/or a downloading options. The side navigation panel 1504 may include graphic display elements, each configured to receive user input and cause performance of specific operations such as rendering of user interface display screens directed to options or links such as: administrative options or links, media player options or links, triggering options or links (e.g., of one or more of the sensors included in the automated inventory intelligence system 700 as seen in FIGS. 7A-7B), etc.

The first graphical display area 1506 and the second graphical display area 1508 may provide information pertaining to the traffic density information in a graphical user interface format including a graphical display of dwell time of shoppers by the hour of the day for a given period of time (e.g., the first graphical display area 1506) and/or a graphical display of proximity triggering events by the hour of the day for a given period of time (second graphical display area 1508).

Referring now to FIG. 15B, an exemplary embodiment of a second user interface display screen produced by an automated inventory intelligence system, where the second user interface display screen provides an interactive dashboard is shown, in accordance with some embodiments. The second user interface display screen 1510 generated in many embodiments by either the proximity logic 728 and/or the alert generation logic 724, and rendered by the alert generation logic 724 comprises a plurality of display areas including the top navigation panel 1502, the side navigation panel 1504, a third graphical display area 1512 and a fourth graphical display area 1514.

The third graphical display area 1512 and the fourth graphical display area 1514 may provide information pertaining to the traffic density information in a graphical user interface format including a graphical display of an average shopper count by the hour of the day for a given period of time (e.g., the third graphical display area 1512) and/or a graphical display of average shopper count by the day of the week for a given period of time (fourth graphical display area 1514). It should be noted that the graphical displays provided by the graphical display areas 1506, 1508, 1512 and 1514 are merely examples and representative of graphical displays that may be generated by the proximity logic 728 and/or the alert generation logic 724 based at least in part on the traffic density information.

Referring now to FIGS. 16-20, a smart store management tool that may enables users to design and stock an entire retail environment, such as a retail store or the like. The smart store management tool depicted in FIGS. 16-20 may be substantially similar to the store management logic 729 with the tool data store 755 that are depicted in FIGS. 7A-B. As noted above, the smart store management tool of FIGS. 16-20 may include a store builder that enables the user to use familiar designing and/or building techniques that may be used to create a variety of layouts of the entire retail store, as well as organize locations and maintain inventory of various shelving units, gondolas, inventory products, and so on within the store. The smart store management tool of FIGS. 16-20 may include a whole-store view tool that may be configured to show locations and current stock of inventory within the store and enables the users to view the current status of any inventory products at any specific locations within the store. The smart store management tool of FIGS. 16-20 may include an inventory analysis view tool that may be configured to show the locations and current stock of any inventory products on a specific shelving unit, gondola, shelf, and so on, that is selected by the users via the whole-store view tool.

Referring now to FIG. 16, an exemplary embodiment illustration of a whole-store inventory view 1600 that shows the locations and current stock of inventory within a retail store is shown, in accordance with some embodiments. In many embodiments, the whole-store inventory view 1600 may be configured to show a variety of locations and current stock of specified inventory products 1608a-c within the retail store. For example, the automated inventory intelligence system described herein may produce a user interface display screen depicted as the whole-store inventory view 1600 in FIG. 16. In some embodiments, the whole-store inventory view 1600 may be generated by either the proximity logic 728 and/or the alert generation logic 724, and rendered by the alert generation logic 724, in which the whole-store inventory view 1600 may include a plurality of display areas such as a top navigation panel 1602, a side navigation panel 1604, and a first graphical display area 1606.

The top navigation panel 1602 may include graphic display elements, each configured to receive user input and cause performance of specific operations including filtering options and/or a downloading options, such as the data of one or more available stores. The side navigation panel 1604 may include graphic display elements, each configured to receive user input and cause performance of specific operations such as rendering of user interface display screens directed to options or links such as: administrative options or links, media player options or links, triggering options or links (e.g., of one or more of the sensors included in the automated inventory intelligence system 700 as seen in FIGS. 7A-7B), etc.

In several embodiments, the first graphical display area 1606 may provide information pertaining to show the locations and current stock of specified inventory products 1608a-c within the retail store in a graphical user interface format including a graphical display of inventory level may be indicated to a user of the smart store management software tool by way of colors (e.g., the color of the inventory products 1608a-c may be used to indicate different levels of inventory stock concerns or the like). For example, in the illustrated embodiment, a yellow color indicates locations within the retail store where stock is slightly reduced, an orange color indicates locations within the retail store where inventory is running lower and soon needs to be replenished, and a red color indicates locations where inventory is out of stock and needs to be replenished.

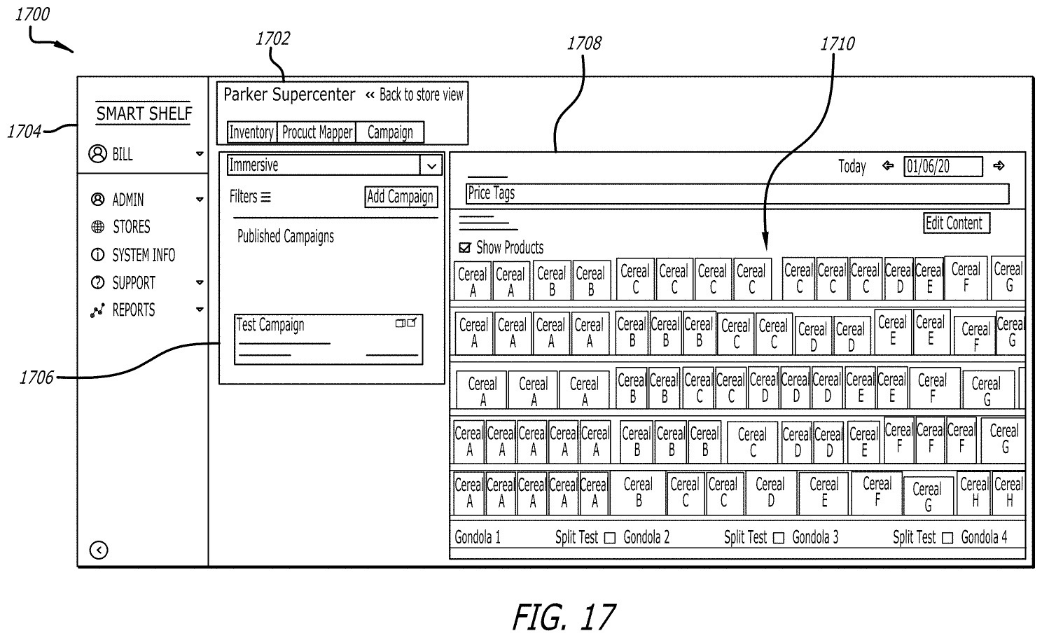

Referring now to FIG. 17, an exemplary embodiment illustration of a product placement view 1700, or a “planogram,” of a gondola within a retail store is shown, in accordance with some embodiments. In many embodiments, the product placement view 1700 may be configured to show a variety of product placement locations, views, and/or current stock of specified inventory products within the retail store. For example, the automated inventory intelligence system described herein may produce a user interface display screen depicted as the product placement view 1700 in FIG. 17. In some embodiments, the product placement view 1700 may be generated by either the proximity logic 728 and/or the alert generation logic 724, and rendered by the alert generation logic 724, in which the product placement view 1700 may include a plurality of display areas such as a top navigation panel 1702, a side navigation panel 1704, a first graphical display area 1706 and a second graphical display area 1708.

The top navigation panel 1702 may include graphic display elements, each configured to receive user input and cause performance of specific operations including filtering options and/or a downloading options, such as the data of one or more available stores. The side navigation panel 1704 and second graphical display area 1708 may include graphic display elements, each configured to receive user input and cause performance of specific operations such as rendering of user interface display screens directed to options or links such as: administrative options or links, media player options or links, triggering options or links (e.g., of one or more of the sensors included in the automated inventory intelligence system 700 as seen in FIGS. 7A-7B), etc.

In several embodiments, the first graphical display area 1706 may provide information pertaining to a shelving unit 1710 within the first graphical display area 1706 of FIG. 17 to display a planogram of the shelving unit 1710. As will be appreciated, the product placement view 1700 of FIG. 17 may be configured to advantageously enable the users to arrange the various locations of inventor product stock on the shelves of the shelving unit 1710.

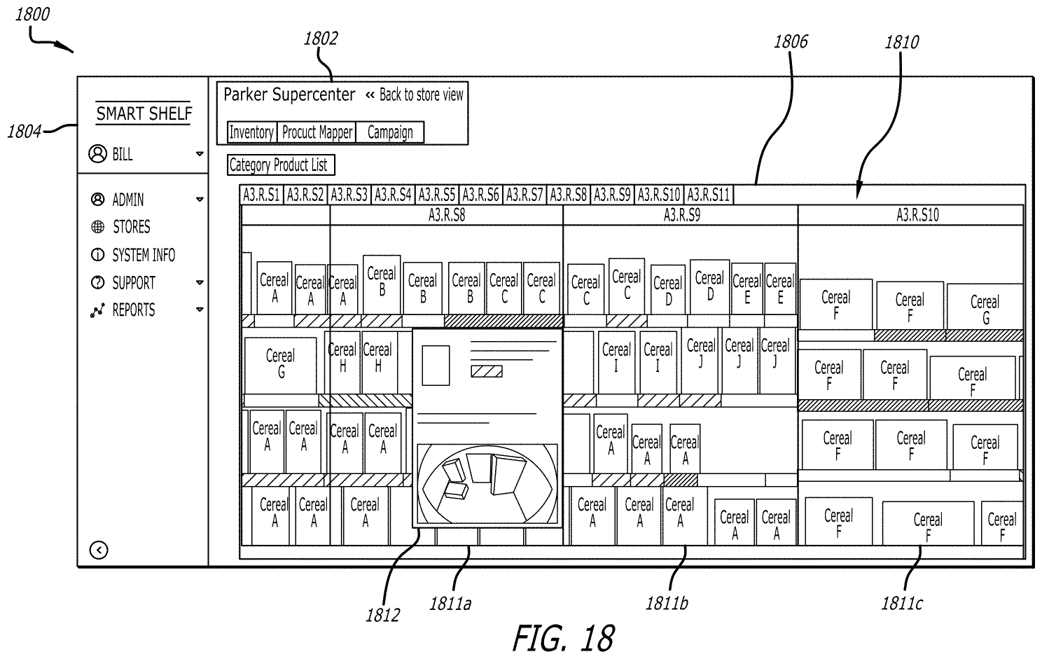

Referring now to FIG. 18, an exemplary embodiment illustration of an inventory analysis view 1800 of a shelving unit 1810 selected in the whole-store view is shown, in accordance with some embodiments. In many embodiments, the inventory analysis view 1800 may be configured to show any desired inventory product analysis and various product placement locations, views, and/or current stock of specified inventory products within the one or more portions 1811a-c within the shelving unit 1810 in the retail store. For example, the automated inventory intelligence system described herein may produce a user interface display screen depicted as the inventory analysis view 1800 in FIG. 18. In some embodiments, the inventory analysis view 1800 may be generated by either the proximity logic 728 and/or the alert generation logic 724, and rendered by the alert generation logic 724, in which the inventory analysis view 1800 may include a plurality of display areas such as a top navigation panel 1802, a side navigation panel 1804, a first graphical display area 1806, and a second graphical display area 1812.

The top navigation panel 1802 may include graphic display elements, each configured to receive user input and cause performance of specific operations including filtering options and/or a downloading options, such as the data of one or more available stores. The side navigation panel 1804 and second graphical display area 1812 may include graphic display elements, each configured to receive user input and cause performance of specific operations such as rendering of user interface display screens directed to options or links such as: administrative options or links, media player options or links, triggering options or links (e.g., of one or more of the sensors included in the automated inventory intelligence system 700 as seen in FIGS. 7A-7B), etc.

In several embodiments, the first graphical display area 1806 may provide information pertaining to one or more inventory analysis views of the shelving unit 1810 selected within the whole-store inventory view of FIG. 16. The first graphical display area 1806 shows the locations and current stock of inventory on the selected shelving unit 1810, where the second graphical display area 1812 may show the specified inventory of one specified portion in the shelving unit 1810. Similarly to the whole-store inventory view 1600 of FIG. 16, the inventory analysis view 1800 may indicate inventory levels by way of colors. For example, a yellow color indicates locations of a gondola containing slightly reduced stock, an orange color indicates locations within the gondola where inventory is running lower than desired, and a red color indicates locations where inventory is out of stock and needs to be replenished.

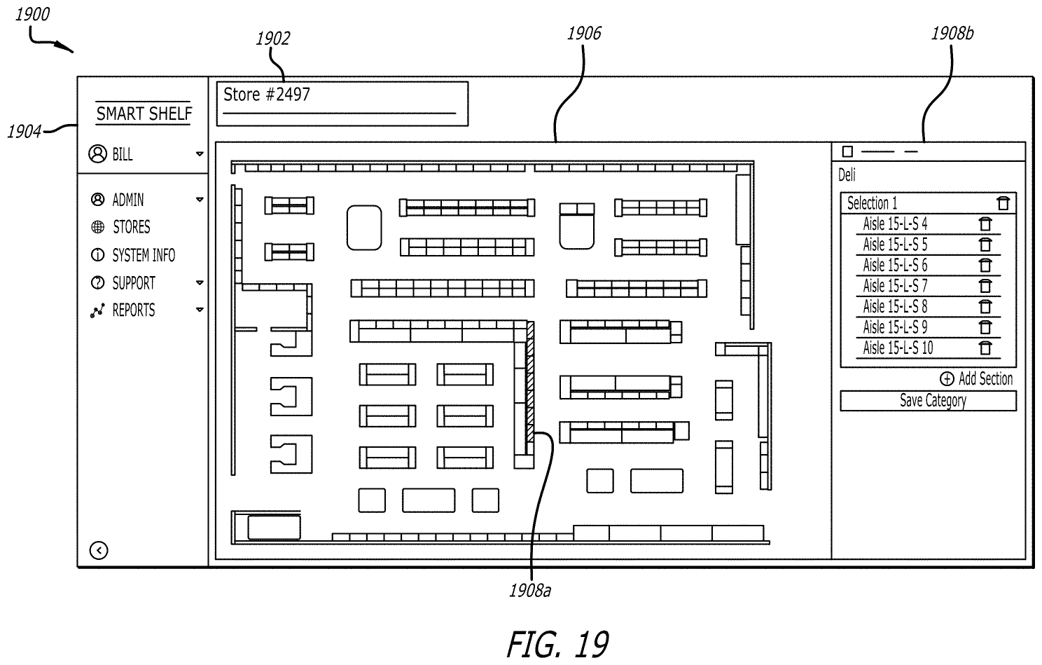

Referring now to FIG. 19, an exemplary embodiment illustration of a whole-store layout view 1900 that shows the locations of gondolas and inventory products within a retail store is shown, in accordance with some embodiments. In many embodiments, the whole-store layout view 1900 may be configured to show any desired inventory product analysis and various product placement locations, views, and/or current stock of specified inventory products within the retail store. For example, the automated inventory intelligence system described herein may produce a user interface display screen depicted as the whole-store layout view 1900 in FIG. 19. In some embodiments, the whole-store layout view 1900 may be generated by either the proximity logic 728 and/or the alert generation logic 724, and rendered by the alert generation logic 724, in which the whole-store layout view 1900 may include a plurality of display areas such as a top navigation panel 1902, a side navigation panel 1904, and a first graphical display area 1906.

The whole-store layout view 1900 may be configured to enable the user arranged gondolas and shelf locations within the retail store. Further, the whole-store layout view 1900 may be configured to enable the user to specify the types of inventory to be stocked on the specific gondolas and shelves within the retail store. Furthermore, the top navigation panel 1902 may include graphic display elements, each configured to receive user input and cause performance of specific operations including filtering options and/or a downloading options, such as the data of one or more available stores. The side navigation panel 1904 and second graphical display area 1908b may include graphic display elements, each configured to receive user input and cause performance of specific operations such as rendering of user interface display screens directed to options or links such as: administrative options or links, media player options or links, triggering options or links (e.g., of one or more of the sensors included in the automated inventory intelligence system 700 as seen in FIGS. 7A-7B), etc.

In several embodiments, the first graphical display area 1906 may provide information pertaining to show the locations and current stock of specified inventory products and respective shelving units 1908a within the retail store in a graphical user interface format including a graphical display 1908b of the selected shelving units 1908a. The graphical display 1908b of the selected shelving units 1908a may depict detailed location and current stock of inventory information of the respective shelving units 1908a selected within the first graphical display area 1906.

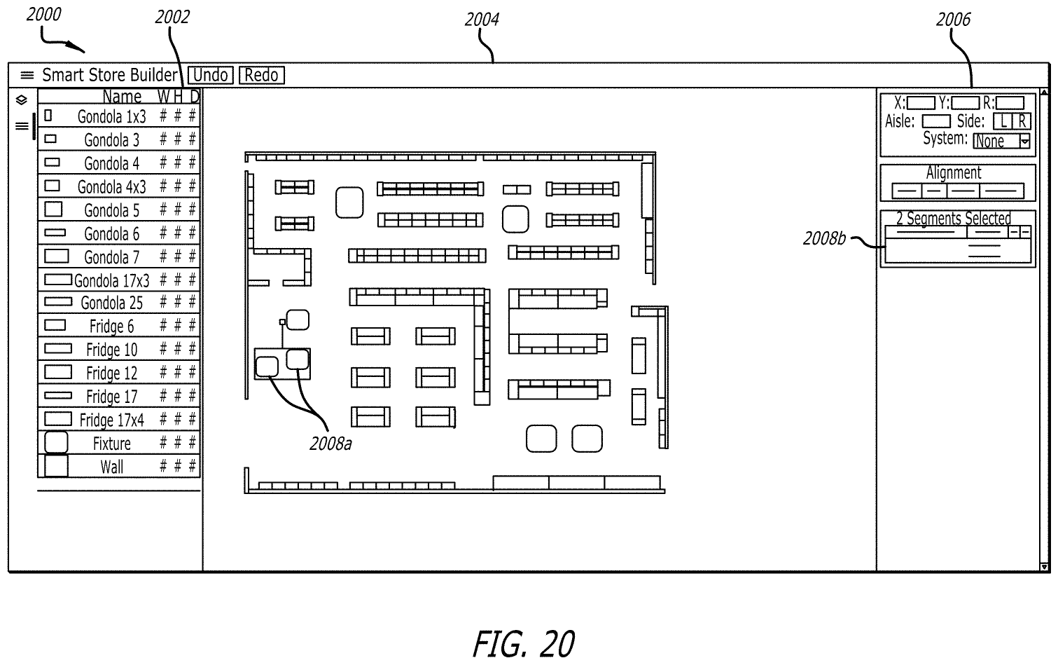

Referring now to FIG. 20, an exemplary embodiment illustration of a store builder view 2000 whereby locations of gondolas and inventory may be organized within a retail store is shown, in accordance with some embodiments. For example, the store builder view 2000 may provide an exemplary locations of gondolas and inventory that may be organized and designed within the retail store. In many embodiments, the store builder view 2000 may be configured to show any desired inventory product analysis and various product placement locations, views, and/or current stock of specified inventory products within the retail store. For example, the automated inventory intelligence system described herein may produce a user interface display screen depicted as the store builder view 2000 in FIG. 20. In some embodiments, the store builder view 2000 may be generated by either the proximity logic 728 and/or the alert generation logic 724, and rendered by the alert generation logic 724, in which the store builder view 2000 may include a plurality of display areas such as a first side navigation panel 2002, a first graphical display area 2004, and a second side navigation panel 2006 having a graphical display area 2008b.

The store builder view 2000 may be configured to enable the users to arranged specified shelving units and shelf locations 2008a within the retail store. In several embodiments, the first (or main) graphical display area 2004 may provide information pertaining to show the locations and current placement of the specified shelving units and shelf locations 2008a within the retail store in a graphical user interface format including the first and second side navigation panels 2002 and 2006, where the second side navigation panel 2006 may depicts data of the selected shelving units 2008a in the graphical display area 2008b. In other words, in some embodiments, the store builder view 2000 may include the first and second side navigation panels 2002 and 2006 (or left-hand/right-hand pane display areas) that shows the currently designed retail store and their respective information, and the first graphical display area 2004 that comprises the store builder view having multiple items, such as gondolas, aisles, shelves, and the like, and that may be inserted into the right-hand pane display area. As such, the store builder view 2000 may be configured to advantageously enable the users to use familiar drag & drop techniques to create various layout designs of the entire retail store.

As will be understood by those skilled in the art, the descriptions of logics utilized in the embodiments depicted in FIGS. 7A-20 are not limiting. In fact, various processes performed by a certain logic (or one or more combined logics) may be configured to be performed by a separate logic, and/or a comparable logic/service located remotely in, for example, a cloud computing service. Indeed, a mix or match of various logics located locally and the remotely may exist within the system.

Information as shown and described in detail herein is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail may be made, without departing from the spirit and scope of the present disclosure, as set forth in the appended claims, as might be apparent to those of ordinary skill in the art, are also encompassed by the present disclosure.

What is claimed is:

1. A smart store management system, comprising:
one or more cameras;
one or more processors communicatively coupled to the one or more cameras; and
a memory communicatively coupled to the one or more processors, the memory comprising:
an image receiving logic to receive an image captured by the one or more cameras;
an object recognition logic to analyze the captured image;
a proximity logic to determine whether a first object within the captured image was detected within a first predetermined proximity region;
an alert generation logic to transmit one or more alerts configured to generate a graphical user interface display screen, wherein the graphical user includes an interface display screen with a plurality of display areas, and wherein at least one or more of the plurality of display areas includes the detected first object within the captured image; and
a management logic to generate a whole view of at least the first object within the first predetermined proximity region, wherein the generated whole view provides a current stock of inventory view at the first predetermined proximity region.

2. The smart store management system of claim 1, wherein at least one or more of the proximity logic and the alert generation logic is further configured to transmit the one or more alerts configured to generate a graphical display to be displayed by one or more fascia, wherein the one or more cameras include one or more proximity cameras coupled to a shelving unit, wherein the shelving unit is located in a retail environment, and wherein the retail environment includes at least one or more of a retail store, a supermarket store, and a wholesale warehouse retailer, and a hypermarket.

3. The smart store management system of claim 2, wherein the management logic is configured to allow a user to design and stock the retail environment, and wherein the management logic is further configured with a builder tool that enables the user to create one or more layouts for the retail environment.

4. The smart store management system of claim 3, wherein the management logic is further configured with an inventory analysis view tool, and wherein the inventory analysis view tool is configured to generate one or more location views of any of one or more gondolas and shelving units in the retail environment.

5. The smart store management system of claim 4, wherein the inventory analysis view tool is configured to generate one or more current stock of inventory lists of any of the one or more gondolas and shelving units in the retail environment.

6. The smart store management system of claim 5, wherein the builder tool is further configured to enable the user to organize one or more locations of gondolas and shelving units, and wherein the builder tool is also configured to enable the user to organize one or more inventory products within the retail environment.

7. The smart store management system of claim 6, wherein the generated whole view is provided by a whole view tool of the management logic, and wherein the whole view tool is further configured to enable the user to view any current status of inventory views at any specific locations within the retail environment.

8. The smart store management system of claim 7, wherein the captured image illustrates a geo-fence region at least partially surrounding the shelving unit, wherein the geo-fence region includes the first predetermined proximity region, and wherein the one or more alerts are transmitted based upon the determination that the first object was detected within the first predetermined proximity region.

9. The smart store management system of claim 8, wherein the proximity logic is further configured to determine whether a second object within the captured image was detected within a second predetermined proximity region, and wherein the second proximity region includes a second physical area that is closer to the shelving unit than a first physical area of the first predetermined proximity region.

10. The smart store management system of claim 9, wherein the captured image is further transmitted to a cloud computing service server configured to analyze at least one of the first and second predetermined proximity regions.

11. The smart store management system of claim 10, wherein the graphical display displayed by the one or more fascia includes an immersive graphic, wherein the immersive graphic spans a plurality of the one or more fascia.

12. The smart store management system of claim 11, further comprising a cabinet display top communicatively coupled to the one or more processors and the memory, wherein the immersive graphic spans a plurality of the one or more fascia and the cabinet display top, wherein the graphical display displayed by the one or more fascia includes a product information graphic, wherein the product information graphic includes at least pricing information for one or more inventory items, wherein the graphical display displayed by the one or more fascia includes a promotional graphic, and wherein the promotional graphic includes at least promotional information associated with at least one or more promotions and discounts for the one or more inventory items.

11. A method for intelligently managing inventory products, the method comprising:
receiving an image captured by a camera;
performing object recognition techniques on the captured image;
determining whether a first object within the captured image was detected within a first predetermined proximity region;
transmitting one or more alerts configured to generate a graphical user interface display screen, wherein the graphical user includes an interface display screen with a plurality of display areas, and wherein at least one or more of the plurality of display areas includes the detected first object within the captured image; and
generating a whole view of at least the first object within the first predetermined proximity region, wherein the generated whole view provides a current stock of inventory view at the first predetermined proximity region.

12. The method of claim 11, wherein at least one or more of the proximity logic and the alert generation logic is further configured to transmit the one or more alerts configured to generate a graphical display to be displayed by one or more fascia, wherein the one or more cameras include one or more proximity cameras coupled to a shelving unit, wherein the shelving unit is located in a retail environment, and wherein the retail environment includes at least one or more of a retail store, a supermarket store, and a wholesale warehouse retailer, and a hypermarket.

13. The method of claim 12, wherein the management logic is configured to allow a user to design and stock the retail environment, and wherein the management logic is further configured with a builder tool that enables the user to create one or more layouts for the retail environment.

14. The method of claim 13, wherein the management logic is further configured with an inventory analysis view tool, and wherein the inventory analysis view tool is configured to generate one or more location views of any of one or more gondolas and shelving units in the retail environment.

15. The method of claim 14, wherein the inventory analysis view tool is configured to generate one or more current stock of inventory lists of any of the one or more gondolas and shelving units in the retail environment.

16. The method of claim 15, wherein the builder tool is further configured to enable the user to organize one or more locations of gondolas and shelving units, and wherein the builder tool is also configured to enable the user to organize one or more inventory products within the retail environment.

17. The method of claim 16, wherein the generated whole view is provided by a whole view tool of the management logic, and wherein the whole view tool is further configured to enable the user to view any current status of inventory views at any specific locations within the retail environment.

18. A smart management tool for intelligently managing and designing inventory products within a retail environment, the tool comprising:
a builder tool configured to allow a user to use one or more designing technique tools, wherein the one or more designing technique tools are configured to create a plurality of layout designs of the retail environment;
a whole view tool configured to generate one or more location views of one or more gondolas and one or more shelving units in the retail environment, and generate one or more current stock of inventory lists of the inventory products that are located in the one or more gondolas and shelving units in the retail environment; and
an inventory analysis view tool configured to generate one or more locations and current stock of inventory views of any of the one or more gondolas and shelving units in the retail environment, wherein the one or more generated locations and current stock of inventory views is selected by the user via the whole view tool.

19. The smart store management tool of claim 18, further comprising a graphical user interface display screen having one or more interface display screens, wherein the graphical user interface display screen allows the user to utilize any of the management tools, and wherein each of the one or more interface display screens includes a plurality of display areas.

20. The smart store management tool of claim 19, wherein the building tool is further configured to enable the user to organize locations of the one or more gondolas and shelving units in the retail environment, wherein the building tool is also configured to enable the user to organize any of the inventory products located on the one or more gondolas and shelving units in the retail environment, wherein the one or more cameras include one or more proximity cameras coupled to a shelving unit, wherein the shelving unit is located in a retail environment, and wherein the retail environment includes at least one or more of a retail store, a supermarket store, and a wholesale warehouse retailer, and a hypermarket.
